(19) United States
(12) Patent Application Publication
(10) Pub. No.: US 2025/0343734 A1
(43) Pub. Date: Nov. 6, 2025

(54) ADAPTIVE AUTO-SCALING OF STREAMING PIPELINES

(71) Applicant: Mellanox Technologies, Ltd., Yokneam (IL)

(72) Inventors: Rohith Basavaraja, Bengaluru (IN); Sharath Ramamurthy, Bangalore (IN); Vinay Prasad V, Bengaluru (IN)

(21) Appl. No.: 18/660,136

(22) Filed: May 9, 2024

Related U.S. Application Data
(60) Provisional application No. 63/642,626, filed on May 3, 2024.

(51) Int. Cl. H04L 41/0896; H04L 41/16

(52) U.S. Cl. CPC H04L 41/0896; H04L 41/16

(57) ABSTRACT

Apparatuses, systems, and techniques to collect network intelligence related to a particular node in a network is passed to an immediate upstream neighbor in the network. The upstream neighbor analyzes the received network intelligence and automatically scales a telemetry streaming pipeline up or down to accommodate telemetry communication with the downstream neighbor in the network.

### CROSS-REFERENCE TO RELATED APPLICATIONS

This application claims the benefit of U.S. Provisional Patent Application No. 63/642,626, filed May 3, 2024, entitled “ADAPTIVE AUTO-SCALING OF STREAMING PIPELINES,” the disclosure of which is herein incorporated in its entirety.

### TECHNICAL FIELD

At least one embodiment pertains to techniques for auto-scaling telemetry streaming pipelines to automatically adjust to changing data traffic patterns.

### BACKGROUND

In large datacenter deployments, great numbers of devices generate telemetry data. Different streams of telemetry data may originate from different source devices and may be transported and/or processed by different telemetry streaming pipelines within a network. The ever-evolving physical and software configurations of such a network require scaling up and down to accommodate the data throughput, which can introduce lag in response times and may result in the loss of data.

### BRIEF DESCRIPTION OF DRAWINGS

FIG. 1 is a block diagram illustrating an example processing system, in accordance with at least one embodiment;

FIG. 2 is a block diagram illustrating an example network, in accordance with at least one embodiment;

FIG. 3 is a block diagram illustrating an example of a portion of a network, in accordance with at least one embodiment;

FIG. 4 illustrates a flowchart of a method, in accordance with at least one embodiment;

FIG. 5A illustrates an example of a system that includes a driver and/or runtime including one or more libraries to provide one or more application programming interfaces (APIs), in accordance with at least one embodiment;

FIG. 5B is block diagram illustrating an example of a processor and modules, according to at least one embodiment;

FIG. 6A illustrates logic, according to at least one embodiment;

FIG. 6B illustrates logic, according to at least one embodiment;

FIG. 7 illustrates an example data center system, according to at least one embodiment; and

FIG. 8 is a block diagram illustrating a computer system, according to at least one embodiment.

### DETAILED DESCRIPTION

In large datacenter deployments, great numbers of devices (e.g., computing devices, sensors, network devices, etc.) generate telemetry data. Network devices (e.g., computing devices, switches, routers, aggregators, telemetry servers, etc.) collect telemetry data that is used, for example, by Artificial Intelligence (“AI”), Machine Learning (“ML”) analytics, and/or advanced computational processes. Different streams of telemetry data may originate from different source devices and may be transported and/or processed by different telemetry streaming pipelines. For example, a typical telemetry streaming pipeline transports data from a source device to one or more intermediate network devices (aggregator(s), telemetry server(s), etc.), and from the intermediate network device(s) to one or more destination devices (e.g., implementing a data lake). Each of at least a portion of the intermediate network device(s) may process the telemetry data. This may include applications and/or services that are directly related to or are components of the telemetry streaming pipeline.

The ever-evolving physical and software configurations of such a network result in changes of the volume of telemetry data generated and may require scaling up and down to accommodate the data throughput. Some systems adapt to changes in data generation with manual scaling of the telemetry streaming pipeline and associated applications. The manual approach can introduce lag in response times and may result in the loss of data. Other techniques monitor a central processing unit (“CPU”), memory, and/or disk utilization to adjust telemetry streaming pipelines. However, these changes are local in nature and are not projected throughout the entire streaming pipeline.

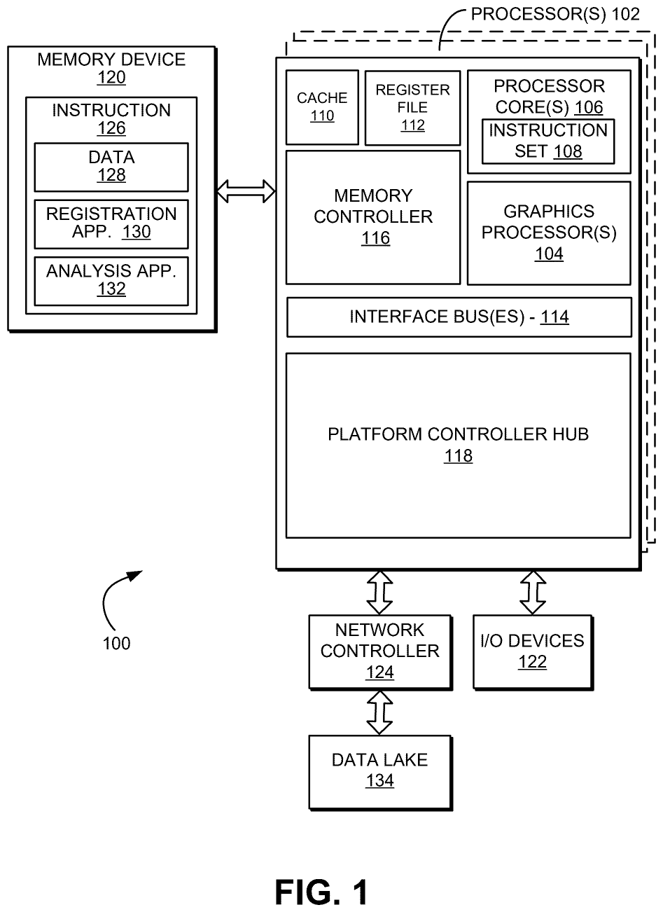

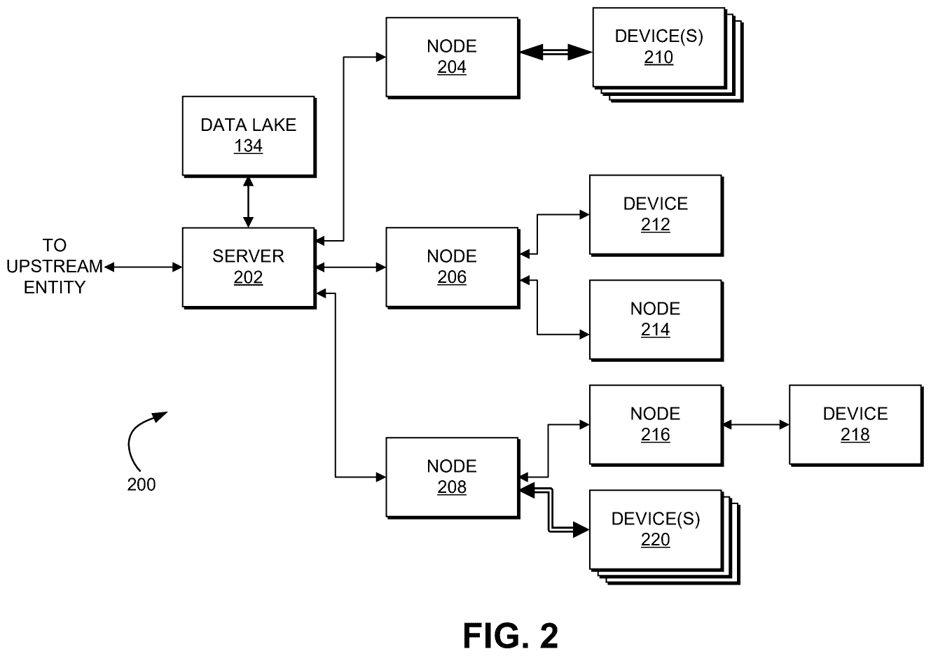

FIG. 1 is a block diagram illustrating an example processing system 100, in accordance with at least one embodiment. The processing system 100 may perform at least a portion of a method of automatically scaling of telemetry streaming pipelines (up and down) based on network intelligence that is gathered by exchanging data that correlates telemetry streams and the related physical/logical entities that form a network (e.g., a network 200 illustrated in FIG. 2). In at least one embodiment, the network intelligence is propagated throughout the processing system 100 from the source to destination and may include all elements of the streaming pipeline.

The processing system 100 may be used to implement one or more network nodes within a computing system (e.g., a data center, cloud computing system, etc.). A network node (as referred to as a node) is a point of intersection and/or connection (e.g., a switch, router, gateway, server, etc.) within a data communication network (e.g., the network 200 illustrated in FIG. 2). A node may be virtual and/or physical. A node includes hardware, software, and/or firmware, such as that described herein with respect to processing system 100. A node may perform operations on data and/or may forward the data onto one or more other nodes in the network (e.g., the network 200 illustrated in FIG. 2).

In at least one embodiment, the processing system 100 includes one or more processors 102 that may include one or more graphics processing units (“GPUs”) 104, and may be a single processor desktop system, a multiprocessor workstation system, or a server system having a large number of processor(s) 102 and/or processor cores 106. For example, the processing system 100 may implement one or more computing devices, one or more network devices (e.g., computing devices, switches, routers, aggregators, telemetry servers, etc.), one or more sensors, a data center, a cloud computing system, and/or the like. In at least one embodiment, the processors core 106 is referred to as a computing unit or compute unit.

In at least one embodiment, the processor(s) 102 each include one or more processor cores 106 to process instructions which, when executed, perform operations for system and user software. In at least one embodiment, each of the one or more processor cores 106 is configured to process a specific instruction set 108. In at least one embodiment, the instruction set 108 may facilitate Complex Instruction Set Computing (“CISC”), Reduced Instruction Set Computing (“RISC”), or computing via a Very Long Instruction Word (“VLIW”). In at least one embodiment, the processor cores 106 may each process a different instruction set 108, which may include instructions to facilitate emulation of other instruction sets. In at least one embodiment, the processor core 106 may also include other processing devices, such as a digital signal processor (“DSP”).

In at least one embodiment, each of the processor(s) 102 includes cache memory (“cache”) 110. In at least one embodiment, each of the processor(s) 102 can have a single internal cache or multiple levels of internal cache. In at least one embodiment, cache memory is shared among various components of each of the processor(s) 102. In at least one embodiment, a register file 112 is additionally included in each of the processor(s) 102 which may include different types of registers for storing different types of data (e.g., integer registers, floating point registers, status registers, and an instruction pointer register). In at least one embodiment, the register file 112 may include general-purpose registers or other registers.

In at least one embodiment, the processor(s) 102 are coupled with one or more interface bus(es) 114 to transmit communication signals such as address, data, or control signals between the processor(s) 102 and other components in processing system 100. In at least one embodiment, the interface bus(es) 114 can be a processor bus, such as a version of a Direct Media Interface (“DMI”) bus. In at least one embodiment, the interface bus(es) 114 is/are not limited to a DMI bus, and may include one or more Peripheral Component Interconnect (“PCI”) buses (e.g., PCI Express (“PCIe”) bus (cs)), one or more memory buses, or other types of interface buses. In at least one embodiment, the processor(s) 102 include an integrated memory controller 116 and a platform controller hub (“PCH”) 118. In at least one embodiment, the memory controller 116 facilitates communication between a memory device 120 and other components of the processing system 100, while the PCH 118 provides connections to Input/Output (“I/O”) devices 122, such as a keyboard, mouse, data storage device, and display unit (not shown), and network controller 124 via a local I/O bus. In at least one embodiment, one or more PCI buses include PCIe Gen 5, which provides an interface for processors.

In at least one embodiment, the memory device 120 can be a dynamic random access memory (“DRAM”) device, a static random access memory (“SRAM”) device, flash memory device, phase-change memory device, or some other memory device having suitable performance to serve as processor memory. In at least one embodiment, memory device 120 can operate as system memory for the processing system 100, to store data 126 and instructions 128 for use when the processor(s) 102 execute(s) an application or process. In at least one embodiment, the memory controller 116 couples with the GPU(s) 104 in processors 102 to perform graphics and media operations.

In at least one embodiment, the processing system 100 includes and/or is connect to a data lake 134 in which the processing system 100 may store telemetry data that is used by AI and/or ML analytics, and/or in advanced computational processes. The data may be stored as structured data, unstructured data, structured data center (“DC”) data, and/or the like.

In at least one embodiment, the memory device 120 includes one or more non-transitory processor-readable medium that stores instructions 128 (e.g., machine executable instructions) that when performed by the processor(s) 102 (e.g., the processor core(s) 106 and/or the GPU(s) 104) implement a registration application 130. As mentioned above, the processing system 100 may be used to implement one or more network nodes within a computing system (e.g., a data center, cloud computing system, etc.), In at least one embodiment, the registration application 130 in each network node identifies at least a portion of physical and/or logical entity(ies) connected to the particular node and identifies a correlation between telemetry streams the identified physical and/or logical entity(ies). The registration application 130 in each network node also identifies applications and services that have dependencies on telemetry streams. The registration application 130 in each network node sends this registration information or record, which may be considered network intelligence, to the upstream neighbor in the network (e.g., the network 200 illustrated in FIG. 2) so that the telemetry streaming pipeline can be scaled up or down based at least in part on the registration record (e.g., the network intelligence) provided by the registration application 130.

As a physical and/or logical entity is added or deleted from a node, the registration application 130 revises the registration record and sends the revised network intelligence to the upstream neighbor in the network (e.g., the network 200 illustrated in FIG. 2) so that the telemetry streaming pipeline can be automatically adjusted based at least in part on the revised network intelligence provided by the registration application 130. Similarly, the registration application 130 revises the registration record to reflect changes in the applications and services provide by the particular node and sends the revised network intelligence to the upstream neighbor in the network (e.g., the network 200 illustrated in FIG. 2) so that the telemetry streaming pipeline can be automatically adjusted based at least in part on the revised network intelligence.

In at least one embodiment, an analysis application 132 receives network intelligence from the immediate downstream network neighbors. The analysis application 132 may use the received network intelligence to determine whether to automatically scale the telemetry pipelines up or down to accommodate expected telemetry traffic. For example, the analysis application 132 may scale the telemetry pipelines up in anticipation of increased telemetry traffic from the immediate downstream network neighbor(s).

In at least one embodiment, the memory device 120 includes one or more non-transitory processor-readable medium that stores instructions 128 (e.g., machine executable instructions) that when performed by the processor(s) 102 (e.g., the processor core(s) 106 and/or the GPU(s) 104) implement the analysis application 132.

In at least one embodiment, the processing system 100 performs a method of evaluating network intelligence to automatically scale telemetry pipelines. The analysis application 132 receives network intelligence from the immediate downstream network neighbors. The analysis application 132 may use the received network intelligence to determine whether to automatically scale the telemetry pipelines up or down to accommodate expected telemetry traffic. For example, the analysis application 132 may scale the telemetry pipelines up in anticipation of increased telemetry traffic from the immediate downstream network neighbors.

FIG. 2 is a block diagram illustrating the example network 200, in accordance with at least one embodiment. A server 202 may be connected to another upstream entity (not shown), such as another server, switch, data center, host, and/or the like. In at least one embodiment, the server 200 is also communicatively coupled to the data lake 134.

In at least one embodiment, the server 202 is also connected to a plurality of downstream nodes 204-208. The term “node” refers to any type of network component, such as switches, routers, gateways, servers, and the like.

In at least one embodiment, the node 204 is coupled to one or more devices 210. The term “device” includes any type of network device and/or component, such as a port, user equipment (UE), computer, switch (e.g., Ethernet switch), router, data processing unit (“DPU”), networking component (e.g., for use with a network, such as Infiniband, NVLink, etc.), or the like. The wide arrow between the node 204 and the devices 210 indicates that there may be independent connections between the node 204 and multiple different devices 210. In at least one embodiment, the node 206 is coupled to a device 212. In the example illustrated in FIG. 2, the node 206 is also connected to a node 214. In the example of FIG. 2, the node 214 may be considered a terminal node because there are no downstream devices coupled to this node.

In the example of FIG. 2, a node 208 is coupled to a node 216 which, in turn is coupled to a device 218. The node 208 is also coupled to one or more device(s) 220, such as those described above. The wide arrow between the node 208 and the devices 220 indicates that there may be independent connections between the node 208 and multiple different devices 220.

In at least one embodiment, the network 200 includes a particular device that uses the registration application 130 to register an association between a particular physical and/or logical entity (e.g., port of the particular device) and each telemetry stream received and/or sent by the particular entity. For example, the node 216 may store a separate registration record (e.g., network intelligence) within a registry that associates the particular entity with a particular telemetry stream. Each registration record identifies a downstream entity, if present, to which the particular entity sends the particular telemetry stream and/or an upstream entity, if present, from which the particular entity receives the particular telemetry stream. This registry allows the particular device to send entity-specific telemetry data related to the particular entity to downstream and/or upstream entity(ies). Each registration record may store information related to the telemetry stream (e.g., type of stream) and/or the particular entity. Thus, the particular device registers and stores mappings that associates each specific network entity (e.g., port) of the particular device with a list of telemetry streams processed by the particular device. This permits targeted data monitoring and management.

In at least one embodiment, each downstream device has the following network intelligence:
1. Telemetry data and/or streams that are sent to upstream device;
2. Correlation between the telemetry streams and the physical/logical entities;
3. Dependencies of application(s) and/or service(s) on telemetry streams; and
4. How to monitor the physical/logical entities.

The above information is provided by every device (e.g., node) in the streaming pipeline to its immediate upstream neighbor. Using this information, the analysis application 132 in each upstream device can correctly estimate a change in volume of telemetry streams before downstream device(s) start transmitting the estimated data volume.

In at least one embodiment, the analysis application 132 in each node (e.g., the node 216) in a network may use its register to identify downstream network entities (e.g., the device 218) connected to the node, upstream network entities (e.g., the node 208) connected to the node, and the various telemetry streams associated with each identified entity. The network entities can be both physical and logical and can further include applications and services that also generate telemetry data.

As mentioned above, the registry allows the particular device to send entity-specific telemetry data related to the particular entity to downstream entity(ies) and/or to upstream entity(ies). In at least one embodiment, the entity-specific telemetry data may identify a change in bandwidth capabilities or capacity with respect to the particular entity and/or other entities in the network 200. For example, a change in the bandwidth capabilities of the node 216 may give rise to changes in the telemetry streams associated with the node 216. In at least one embodiment, each downstream node (e.g., the node 216) sends correlation data between the various entities connected thereto and the telemetry streams as part of the registration record (e.g., network intelligence) with its immediate upstream neighbor(s) (e.g., the node 208). In turn, the analysis application 132 in the upstream node 208 monitors for changes to entities and based on changes, such as additions or deletions, will estimate the volume of telemetry resulting from the changes. The analysis application 132 in the upstream node 208 may take one or more actions to automatically adjust the telemetry streaming pipeline to accommodate one or more of such changes.

The downstream and/or upstream devices may monitor (e.g., listen for) for such entity-specific telemetry data related to the particular entity and/or other entities in the network, and the downstream and/or upstream devices may use this entity-specific telemetry data to modify their operations. In the example above, the node 208 monitors the telemetry data from the node 216 and identifies the new bandwidth capabilities of the node 216. The node 208 can use this new information to automatically scale the telemetry streaming pipeline with the node 216 to adjust for the new bandwidth capabilities. Each telemetry stream has its own data throughput and processing requirements. Thus, the entities (e.g., ports) of the network devices will experience varying loads. In at least one embodiment, the analysis application 132 in each node will automatically adjust the telemetry streaming pipeline with its immediate downstream neighbor. Because each node in the network 200 automatically scales telemetry streaming pipelines with its immediate downstream neighbor, the entire network is effectively adjusted.

The network nodes may receive uploaded entity-specific telemetry streams from any downstream entities or downstream devices. In at least one embodiment, the node 208 can receive telemetry streams from the node 216 as well as any telemetry streams from the device 218. The node 208 can also receive telemetry streams from the device(s) 220. The nodes (e.g., the node 208) may aggregate some of the entity-specific telemetry streams and transmit the entity-specific telemetry streams (aggregated or not) to the next upstream node (e.g., the server 202). The telemetry streams and/or entity-specific telemetry streams may comprise in-band and/or out-of-band telemetry streams. Upstream entities monitor the entity-specific telemetry data from the immediate downstream entity(ies) for the occurrence of one or more events, such as the addition or removal of a device or change in the processing capacity (e.g., bandwidth capabilities) of the particular entity and/or other entities in the network, to ensure that the entire network 200 can adapt to changes in the demands of data flow and processing requirements.

In at least one embodiment, the entity-specific telemetry streams may be transported by the telemetry streaming pipelines, filtered, and/or transformed for integration into the data lake 134 that collects, for example, data related to AI/ML tools and/or Business Logic applications.

In at least one embodiment, the network node (e.g., the node 206) may use data included in the entity-specific telemetry streams that the network node receives from other network nodes to allocate and manage application instances responsible for handling the telemetry stream processing. The network node may use data included in the entity-specific telemetry streams that the network node receives from other network nodes to balance work within the network by selecting nodes with sufficient capacity to process a particular telemetry stream. The network node may use data included in the entity-specific telemetry streams that the network node receives from other network nodes to increase and/or decrease a data rate (or bandwidth) that the network node uses to transmit telemetry data to one or more downstream devices. The application processing capability may be taken into account in determining telemetry streaming pipeline requirements and/or configuration. Thus, at least a portion of the telemetry streaming pipeline may be scaled up by allocating more compute resources to the telemetry streaming pipeline, launch additional processes (e.g., VMs), and/or using additional bandwidth to process the telemetry data.

Each node in the network 200 is responsible for auto-scaling its portion of one or more telemetry streaming pipelines based at least in part on one or more entity-specific telemetry streams received by the node from one or more other network nodes. Each node in the network monitors the entity-specific telemetry stream(s) received from registered upstream and/or registered downstream devices, scales, if appropriate, its portion of the telemetry streaming pipeline(s), and sends entity-specific telemetry stream(s) to upstream and/or downstream devices to notify them of any changes to the telemetry streaming pipeline(s). The next upstream and/or downstream entity uses this information to perform the same tasks, namely scaling, if appropriate, its portion of the telemetry streaming pipeline(s), and sending entity-specific telemetry stream(s) to upstream and/or downstream devices to notify them of any changes to the telemetry streaming pipelines. With each node responsible for auto-scaling its portion of a telemetry streaming pipeline to improve the telemetry streaming pipeline (e.g., at least a downstream portion of the telemetry streaming pipeline), and passing the telemetry data upstream, the entire network may be optimized for telemetry streaming.

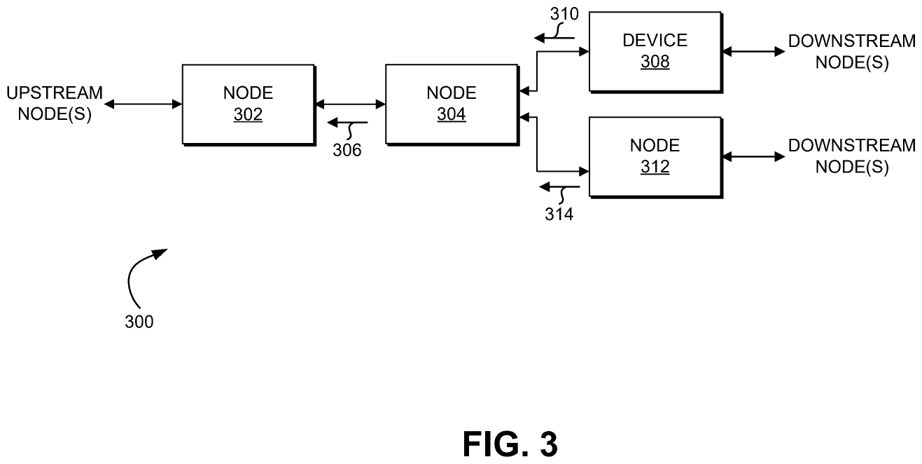

FIG. 3 is a block diagram illustrating an example of a portion of a network 300, in accordance with at least one embodiment. FIG. 3 uses the network 300 to illustrate an example of the autoscaling process. In FIG. 3, a node 302 may be connected to one or more upstream nodes (not shown). A node 304 is connected downstream from the node 302. FIG. 3 illustrates a communication channel 306 representing the upstream telemetry streaming pipeline from the node 304 to the node 302.

Additional nodes 308 and 312 are connected downstream from the node 304. FIG. 3 also illustrates communication channels 310 and 314 representing the upstream telemetry streaming pipelines from the nodes 308 and 312, respectively, to the node 304. In at least one embodiment, as noted above, the node 308 uses the registration application 130 to register all physical and logical entities connected thereto, including any additional downstream node(s) (not shown). The node 308 also uses the registration application 130 to register any applications/services for which telemetry stream(s) will be generated, including any additional telemetry stream(s) generated by any downstream node(s) (not shown). The node 308 also uses the registration application 130 to monitor the various physical/logical entities and applications/process connected directly to the node 308 itself. This registration record (e.g., network intelligence) is passed to the upstream neighbor (the node 304 in the example of FIG. 3) via the communication channel 310. Registration records related to any changes in the node 308 is passed to the upstream neighbor (the node 304 in the present example). The network intelligence may also include changes in registration records received from any downstream nodes (not shown) connected to the node 308.

Similarly, the node 312 registers all physical and logical entities connected thereto, including any additional downstream node(s) (not shown). The node 312 uses the registration application 130 to register all physical and logical entities connected thereto, including any additional downstream node(s) (not shown). The node 312 also uses the registration application 130 to register any applications/services for which telemetry stream(s) will be generated, including any additional telemetry stream(s) generated by any downstream node(s) (not shown). The node 312 also uses the registration application 130 to monitor the various physical/logical entities and applications/process connected directly to the node 312 itself. This registration record is passed to the upstream neighbor (the node 304 in the example of FIG. 3) via the communication channel 314. Registration records (e.g., network intelligence) related to any changes in the node 312 is passed to the upstream neighbor (the node 304 in the present example). The network intelligence also includes changes in registration records received from any downstream nodes (not shown) connected to the node 312.

The node 304 registers all physical and logical entities connected thereto, including the downstream nodes 308 and 312. The node 304 also registers any applications/services for which telemetry stream(s) will be generated, including any additional telemetry stream(s) generated by the downstream nodes 308 and 312. The node 304 also monitors the various physical/logical entities and applications/process connected directly to the node 304 itself. This registration record is passed to the upstream neighbor (the node 302 in the example of FIG. 3) via the communication channel 306. Registration records related to any changes in the node 308 and/or the node 312 is reflected in changes to the registration record for the node 304, and is also passed to the upstream neighbor (the node 302 in the example of FIG. 3). This registration record also includes registration record received from any downstream nodes (not shown) connected to the nodes 308 and 312.

In at least one embodiment, each node in the network 300 collects registration records about telemetry streams that are sent to the upstream neighbor, a correlation between the telemetry streams and the physical/logical entities, application and services dependencies on telemetry streams and monitors the physical/logical entities. This network intelligence is propagated throughout the network 300 by passing the information from one node to the upstream neighbor. All network intelligence collected by nodes 308 and 312 is passed up to node 304. In turn, the node 304 passes the network intelligence from node 308 and 312, as well as any network intelligence related to physical/logical entities, and application and services dependencies on telemetry streams resulting from the node 304 itself.

In at least one embodiment, the node 302 receives collective network intelligence passed up from the nodes 304, 308, and 312. This collective network intelligence is passed from the node 302 to the upstream neighbor (not shown). The node 302 also passes any network intelligence related to physical/logical entities, and application and services dependencies on telemetry streams resulting from the node 302 itself to the upstream neighbor (not shown).

In at least one embodiment, the analysis application 132 in each node processes the received network intelligence to automatically scale the streaming pipeline between the node and its downstream neighbor. In the example of FIG. 3, the analysis application 132 in the node 304 can automatically scale the streaming pipeline 310 between the node 304 and the node 310 based on the network intelligence that the node 304 has received from the node 308.

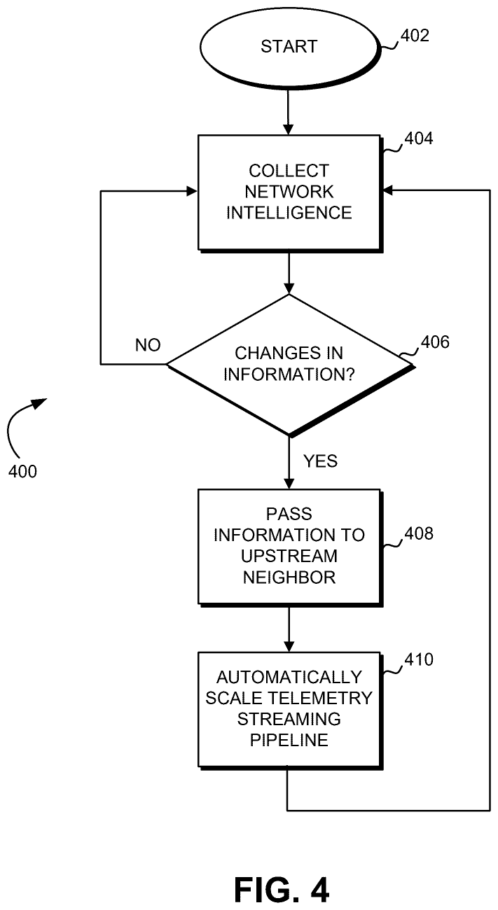

FIG. 4 is a flowchart 400 of a method 400, in accordance with at least one embodiment. At a start 402, the network (e. g., the network 200) is established. At block 404, the registration application 130 of each node (e.g., the node 214) performs a registration process to collect network intelligence, including telemetry streams that are sent to the neighboring upstream device (e.g., the node 208), correlation between the telemetry streams and the physical/logical entities connected to the particular node, application and services dependencies on telemetry streams related to the particular node, and how to monitor the physical/logical entities connected to the particular node.

At decision block 406, the analysis application 132 of one or more nodes each determines whether there are changes in the registration information to report to the neighboring upstream device(s) (e.g., the node 208). If there are no changes to be reported, the answer to decision block 406 is NO and process returns to block 404 to continue monitoring for registration changes in the node (e.g., the node 216). If there are changes to be reported, the answer to decision block 406 is YES, and in block 408, the node(s) (e.g., the node 216) each passes the registration information or revised registration information to the neighboring upstream device (e.g., the node 208).

At block 410, the neighboring upstream device(s) (e.g., the node 208) each automatically scales the telemetry streaming pipeline based at least in part on the received registration information. In at least one embodiment, the analysis application 132 in the neighboring upstream device (e.g., the node 208) uses the received registration information to scale the telemetry streaming pipeline (up or down) in response to the expected needs of the downstream neighbor (e.g., the node 216). Following the automatic scaling operation, the node(s) each returns to block 404 to continue monitoring for registration changes in the node (e.g., the node 216).

In at least one embodiment, this process illustrated in FIG. 4 is performed by each node in the telemetry streaming pipeline with the registration information from each node being passed up to the upstream neighbor. For example, the process of FIG. 4 described above with respect to the node 216 is also performed by the node 208, which collects registration information for the node 216 and the device(s) 220. This registration information is passed up to the upstream neighbor (e.g., the server 202). The server 202 performs the automatic scaling operation of block 410 based at least in part on the registration information received from the node 208. Thus, the registration information is propagated throughout all nodes in the network 200.

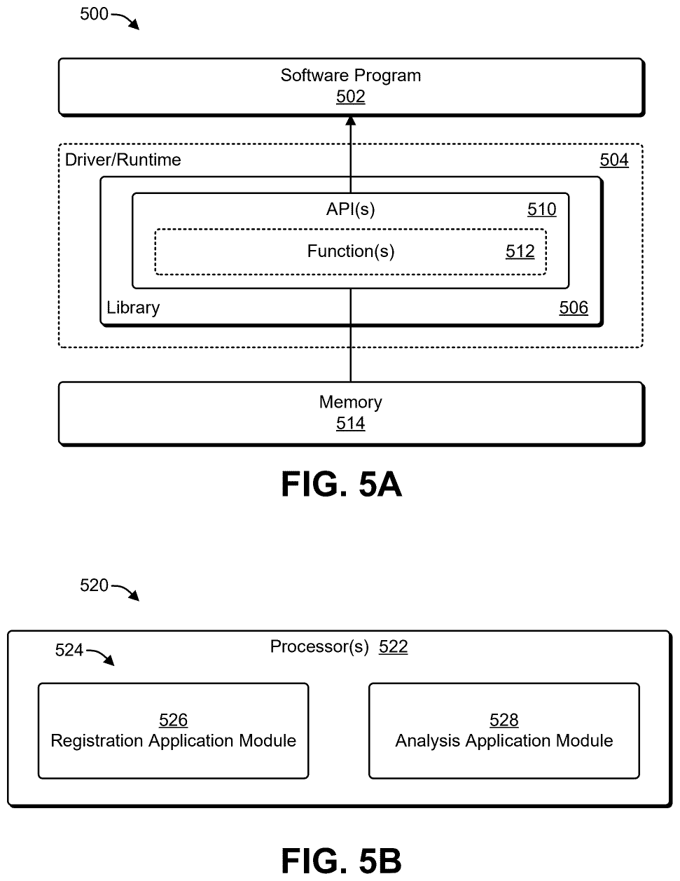

FIG. 5A illustrates an example of a system 500 that includes one or more drivers and/or one or more runtimes (illustrated as reference numeral 504) including one or more libraries 506 to provide one or more application programming interfaces (“API(s)”) 510, in accordance with at least one embodiment. In at least one embodiment, the system 500 includes the driver(s) 504 and/or the runtime(s) 504 including the library(ies) 506 to provide to the API(s) 510. In at least one embodiment, the API(s) 510 is/are sets of software instructions that, if executed, cause one or more processors (e.g., processor(s) 522 illustrated in FIG. 5B) to perform one or more computational operations. In at least one embodiment, one or more of the API(s) 510 is/are distributed or otherwise provided as a part of one or more of the library(ies) 506, one or more of the runtime(s) 504, one or more of the driver(s) 504, and/or one or more component of any other grouping of software and/or executable code further described herein. In at least one embodiment, one or more of the API(s) 510 perform one or more computational operations in response to invocation by one or more software programs 502.

In at least one embodiment, one or more of the software program(s) 502 is/are a software module and/or include(s) one or more software modules. In at least one embodiment, a software module is as further illustrated non-exclusively in FIG. 5B as one or more modules 524 and described with respect thereto. In at least one embodiment, one or more of the software program(s) 502 is/are a collection of software code, commands, instructions, and/or other sequences of text to instruct a computing device (e.g., the processor(s) 102) to perform one or more computational operations and/or invoke one or more other sets of instructions, such as the API(s) 510 or API function(s) 512, to be executed by the computing device. In at least one embodiment, functionality provided by one or more of the API(s) 510 includes the API function(s) 512, such as those usable to accelerate one or more portions of the software program(s) 502 using one or more parallel processing units (PPUs), such as graphics processing units (GPUs).

In at least one embodiment, one or more of the API(s) 510 is/are one or more hardware interfaces to one or more circuits to perform one or more computational operations. In at least one embodiment, one or more of the API(s) 510 described herein are implemented as one or more circuits to perform one or more techniques described in connection with FIGS. 1-4. In at least one embodiment, one or more of the software program(s) 502 include instructions that, if executed, cause one or more hardware devices and/or circuits to perform one or more techniques further described in connection with FIGS. 1-4. In at least one embodiment, the system 500 includes one or more or all components of the system 100 described in relation to FIG. 1, and the system 500 may perform one or more or all of the processes and/or operations that the systems and components of the system 100 perform.

In at least one embodiment, the software program(s) 502, such as user-implemented software programs, utilize one or more of the API(s) 510 to perform various computing operations, such as memory reservation, matrix multiplication, arithmetic operations, and/or any computing operation performed by PPUs, such as GPUs, as further described herein. In at least one embodiment, the function(s) 512 include a set of callable functions provided by one or more of the API(s) 510 that are referred to herein as APIs, API functions, software functions, and/or functions, that individually perform one or more computing operations, such as computing operations related to parallel computing. In at least one embodiment, one or more of the API(s) 510 perform tasks, such as identifying downstream network components connected to a particular node e.g., the node 206), and/or perform other operations described herein (e.g., in connection with FIGS. 1-4).

In at least one embodiment, one or more of the software program(s) 502 interact or otherwise communicate with one or more of the API(s) 510 to perform one or more computing operations using one or more processors (e.g., processor(s) 522 illustrated in FIG. 5B), such as one or more PPUs, such as GPUs. In at least one embodiment, one or more computing operations using one or more PPUs include at least one or more groups of computing operations to be accelerated by execution at least in part by said one or more PPUs. In at least one embodiment, one or more of the software program(s) 502 interact with one or more of the API(s) 510 to control communication between network nodes (e.g., communication between the nodes 206 and 214), and/or perform other operations described herein (e.g., in connection with FIGS. 1-4).

In at least one embodiment, an interface is software instructions that, if executed, provide access to one or more of the function(s) 512 provided by one or more of the API(s) 510. In at least one embodiment, one or more of the software program(s) 502 use(s) a local interface when a software developer compiles one or more of the software program(s) 502 in conjunction with one or more of the library(ies) 506 including or otherwise providing access to one or more of the API(s) 510. In at least one embodiment, one or more of the software program(s) 502 is/are compiled statically in conjunction with one or more pre-compiled ones of the library(ies) 506 and/or uncompiled source code including instructions to perform one or more of the API(s) 510. In at least one embodiment, one or more of the software program(s) 502 are compiled dynamically and the dynamically compiled software program(s) utilize a linker to link to one or more pre-compiled ones of the library(ies) 506, including one or more of the API(s) 510.

In at least one embodiment, one or more of the software program(s) 502 use(s) a remote interface when a software developer executes a software program that utilizes or otherwise communicates with at least one of the library(ies) 506 including one or more of the API(s) 510 over a network or other remote communication medium. In at least one embodiment, one or more of the library(ies) 506 including one or more of the API(s) 510 are to be performed by a remote computing service, such as a computing resource services provider. In at least one embodiment, one or more of the library(ies) 506 including one or more particular APIs (of the API(s) 510) is/are to be performed by any other computing host providing the particular API(s) to one or more of the software program(s) 502.

In at least one embodiment, a processor (e.g., processor(s) 522 illustrated in FIG. 5B) performing or using one or more particular ones of the software program(s) 502 calls, uses, performs, and/or otherwise implements one or more of the API(s) 510 to allocate and otherwise manage memory 514 to be used by the particular software program(s). In at least one embodiment, one or more particular ones of the software program(s) 502 utilize one or more of the API(s) 510 to allocate and otherwise manage the memory 514 to be used by one or more portions of the particular software program(s) to be accelerated using one or more PPUs, such as GPUs, or any other accelerator or processor further described herein. In at least one embodiment, one or more of the software program(s) 502 request one or more neural networks to perform signal processing using one or more of the function(s) 512 provided by one or more of the API(s) 510. In at least one embodiment, the memory device 120 implements memory 514.

In at least one embodiment, one or more of the API(s) 510 is an API to facilitate parallel computing. In at least one embodiment, one or more of the API(s) 510 is any other API further described herein. In at least one embodiment, one or more of the API(s) 510 is/are provided by one or more of the driver(s) 504 and/or one or more of the runtime(s) 504. In at least one embodiment, one or more of the API(s) 510 is/are provided by a CUDA user-mode driver. In at least one embodiment, one or more of the API(s) 510 is/are provided by a CUDA runtime. In at least one embodiment, one or more of the driver(s) 504 is/are data values and software instructions that, if executed, perform and/or otherwise facilitate operation of one or more of the function(s) 512 of one or more of the API(s) 510 during load and execution of one or more portions of at least one of the software program(s) 502. In at least one embodiment, one or more of the runtime(s) 504 is/are data values and/or software instructions that, if executed, perform or otherwise facilitate operation of one or more of the function(s) 512 of one or more of the API(s) 510 during execution of at least one of the software program(s) 502. In at least one embodiment, one or more particular ones of the software program(s) 502 utilize one or more of the API(s) 510 implemented and/or otherwise provided by one or more of the driver(s) 504 and/or one or more of the runtime(s) 504 to perform combined arithmetic operations by the particular software program(s) during execution by one or more PPUs, such as GPUs.

In at least one embodiment, one or more of the software program(s) 502 utilize one or more of the API(s) 510 provided by one or more of the driver(s) 504 and/or one or more of the runtime(s) 504 to perform combined arithmetic operations of one or more PPUs, such as GPUs. In at least one embodiment, one or more of the API(s) 510 provide combined arithmetic operations through one or more of the driver(s) 504 and/or one or more of the runtime(s) 504, as described above. In at least one embodiment, one or more of the software program(s) 502 utilize one or more of the API(s) 510 provided by one or more of the driver(s) 504 and/or one or more of the runtime(s) 504 to allocate or otherwise reserve one or more blocks of the memory 514 of one or more PPUs, such as GPUs. In at least one embodiment, one or more of the software program(s) 502 utilize one or more of the API(s) 510 provided by one or more of the driver(s) 504 and/or one or more of the runtime(s) 504 to allocate or otherwise reserve blocks of the memory 514.

In at least one embodiment, to improve usability of one or more particular ones of the software program(s) 502 and/or improve performance, one or more portions of the particular software programs are to be accelerated by one or more PPUs (such as GPUs). In at least one embodiment, one or more of the function(s) 512 receive one or more input parameters indicating one or more inputs to one or more neural networks and/or other data to be utilized by the neural network(s), such as one or more hyperparameters of the neural network(s). In at least one embodiment, the input parameter(s) include the one or more inputs and/or the other data. In at least one embodiment, the input parameter(s) include one or more pointers to one or more memory locations where the input(s) and/or the other data is/are stored.

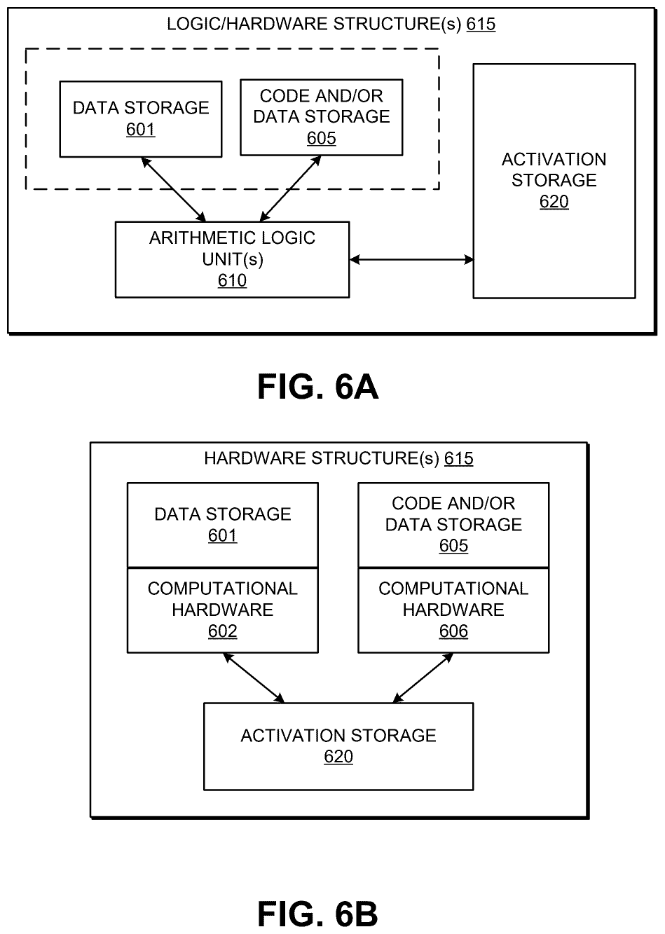

In at least one embodiment, the system 500 includes at least one processor (e.g., processor(s) 522 illustrated in FIG. 5B) including one or more circuits to perform one or more software programs to combine two or more of the API(s) 510 into a single API. In at least one embodiment, the system 500 includes at least one processor (e.g., processor(s) 522 illustrated in FIG. 5B) that uses one or more of the API(s) 510 to control communication between network nodes, and/or otherwise perform operations described herein. In at least one embodiment, the system 500 includes at least one processor (e.g., processor(s) 522 illustrated in FIG. 5B) that uses one or more of the API(s) 510 to perform one or more operations illustrated in and/or described with respect to one or more of FIGS. 1-4, such as one or more processes illustrated in the flowchart of FIG. 4 or portion(s) thereof. In at least one embodiment, the system 500 includes at least one processor (e.g., processor(s) 522 illustrated in FIG. 5B) to perform one or more of the function(s) 512, such as those described in connection with FIGS. 1-4. In at least one embodiment, one or more of the API(s) 510 is to be performed by hardware described in connection with FIGS. 6-8.

FIG. 5B is block diagram 520 illustrating example processor(s) 522 and the module(s) 524, according to at least one embodiment. Referring to FIG. 5B, in at least one embodiment, the processor(s) 522 may be implemented by the processor(s) 102 in FIG. 1. In at least one embodiment, the processor(s) 522 may perform one or more processes such as those described herein with respect executing the software code for the registration application 130 and the analysis application 132 and/or may otherwise perform operations described herein. In at least one embodiment, the processor(s) 522 perform(s) one or more processes such as those described in connection with FIGS. 1-4.

In at least one embodiment, the processor(s) 522 include one or more processors such as those described in connection with FIGS. 6-8. In at least one embodiment, processor(s) 522 may be any suitable processing unit and/or combination of processing units, such as one or more CPUs, GPUs, DPUs, GPGPUs, PPUs, and/or variations thereof. The processor(s) 522 includes the module(s) 524, which may include a registration application module 526 to implement the registration application 130 and an analysis application module 528 to implement the analysis application 132. The module(s) 524 may be distributed among multiple processors that communicate over a bus, network, by writing to shared memory, and/or any suitable communication process such as those described herein. In at least one embodiment, the module(s) 524 may include processor executable instructions that implement the registration application 130 and the analysis application 132. In at least one embodiment, individual nodes illustrated in FIGS. 2 and 3 could also be implemented using the hardware and logic structure illustrated in FIGS. 6A and 6B.

As used in any implementation described herein, unless otherwise clear from context or stated explicitly to contrary, a module refers to any combination of software logic, firmware logic, hardware logic, and/or circuitry configured to provide functionality described herein. Software may be embodied as a software package, code and/or instruction set or instructions, and “hardware,” as used in any implementation described herein, may include, for example, singly or in any combination, hardwired circuitry, programmable circuitry, state machine circuitry, fixed function circuitry, execution unit circuitry, and/or firmware that stores instructions executed by programmable circuitry. Modules may, collectively or individually, be embodied as circuitry that forms part of a larger system, for example, an integrated circuit (IC), system on-chip (SoC), and so forth. a module performs one or more processes in connection with any suitable processing unit and/or combination of processing units, such as one or more CPUs, GPUs, GPGPUs, DPUs, PPUs, and/or variations thereof.

In at least one embodiment, as used in any implementation described herein, unless otherwise clear from context or stated explicitly to contrary, terms such as “module” and nominalized verbs (e.g., image manager, image analyzer, analytics engine, controller, and/or other terms) each refers to any combination of software logic, firmware logic, hardware logic, and/or circuitry configured to provide functionality described herein. In at least one embodiment, software may be embodied as a software package, code and/or instruction set or instructions, and “hardware,” as used in any implementation described herein, may include, for example, singly or in any combination, hardwired circuitry, programmable circuitry, state machine circuitry, fixed function circuitry, execution unit circuitry, and/or firmware that stores instructions executed by programmable circuitry. In at least one embodiment, modules may, collectively or individually, be embodied as circuitry that forms part of a larger system, for example, an integrated circuit (IC), system on-chip (SoC), and so forth.

### Logic

FIG. 6A illustrates logic 615 which, as described elsewhere herein, can be used in one or more devices to perform operations such as those discussed herein in accordance with at least one embodiment. In at least one embodiment, logic 615 is used to perform inferencing and/or training operations associated with one or more embodiments. In at least one embodiment, logic 615 is inference and/or training logic. Details regarding logic 615 are provided below in conjunction with FIGS. 6A and/or 6B. In at least one embodiment, logic refers to any combination of software logic, hardware logic, and/or firmware logic to provide functionality or operations described herein, wherein logic may be, collectively or individually, embodied as circuitry that forms part of a larger system, for example, an integrated circuit (IC), system-on-chip (SoC), or one or processors (e.g., CPU, GPU).

In at least one embodiment, logic 615 may include, without limitation, code and/or data storage 601 to store forward and/or output weight and/or input/output data, and/or other parameters to configure neurons or layers of a neural network trained and/or used for inferencing in aspects of one or more embodiments. In at least one embodiment, logic 615 may include, or be coupled to code and/or data storage 601 to store graph code or other software to control timing and/or order, in which weight and/or other parameter information is to be loaded to configure, logic, including integer and/or floating point units (collectively, arithmetic logic units (ALUs)). In at least one embodiment, code, such as graph code, loads weight or other parameter information into processor ALUs based on an architecture of a neural network to which such code corresponds. In at least one embodiment, code and/or data storage 601 stores weight parameters and/or input/output data of each layer of a neural network trained or used in conjunction with one or more embodiments during forward propagation of input/output data and/or weight parameters during training and/or inferencing using aspects of one or more embodiments. In at least one embodiment, any portion of code and/or data storage 601 may be included with other on-chip or off-chip data storage, including a processor's L1, L2, or L3 cache or system memory.

In at least one embodiment, any portion of code and/or data storage 601 may be internal or external to one or more processors or other hardware logic devices or circuits. In at least one embodiment, code and/or code and/or data storage 601 may be cache memory, dynamic randomly addressable memory (“DRAM”), static randomly addressable memory (“SRAM”), non-volatile memory (e.g., flash memory), or other storage. In at least one embodiment, a choice of whether code and/or code and/or data storage 601 is internal or external to a processor, for example, or including DRAM, SRAM, flash or some other storage type may depend on available storage on-chip versus off-chip, latency requirements of training and/or inferencing functions being performed, batch size of data used in inferencing and/or training of a neural network, or some combination of these factors.

In at least one embodiment, logic 615 may include, without limitation, a code and/or data storage 605 to store backward and/or output weight and/or input/output data corresponding to neurons or layers of a neural network trained and/or used for inferencing in aspects of one or more embodiments. In at least one embodiment, code and/or data storage 605 stores weight parameters and/or input/output data of each layer of a neural network trained or used in conjunction with one or more embodiments during backward propagation of input/output data and/or weight parameters during training and/or inferencing using aspects of one or more embodiments. In at least one embodiment, logic 615 may include, or be coupled to code and/or data storage 605 to store graph code or other software to control timing and/or order, in which weight and/or other parameter information is to be loaded to configure, logic, including integer and/or floating point units (collectively, arithmetic logic units (ALUs)).

In at least one embodiment, code, such as graph code, causes the loading of weight or other parameter information into processor ALUs based on an architecture of a neural network to which such code corresponds. In at least one embodiment, any portion of code and/or data storage 605 may be included with other on-chip or off-chip data storage, including a processor's L1, L2, or L3 cache or system memory. In at least one embodiment, any portion of code and/or data storage 605 may be internal or external to one or more processors or other hardware logic devices or circuits. In at least one embodiment, code and/or data storage 605 may be cache memory, DRAM, SRAM, non-volatile memory (e.g., flash memory), or other storage. In at least one embodiment, a choice of whether code and/or data storage 605 is internal or external to a processor, for example, or including DRAM, SRAM, flash memory or some other storage type may depend on available storage on-chip versus off-chip, latency requirements of training and/or inferencing functions being performed, batch size of data used in inferencing and/or training of a neural network, or some combination of these factors.

In at least one embodiment, code and/or data storage 601 and code and/or data storage 605 may be separate storage structures. In at least one embodiment, code and/or data storage 601 and code and/or data storage 605 may be a combined storage structure. In at least one embodiment, code and/or data storage 601 and code and/or data storage 605 may be partially combined and partially separate. In at least one embodiment, any portion of code and/or data storage 601 and code and/or data storage 605 may be included with other on-chip or off-chip data storage, including a processor's L1, L2, or L3 cache or system memory.

In at least one embodiment, logic 615 may include, without limitation, one or more arithmetic logic unit(s) (“ALU(s)”) 610, including integer and/or floating point units, to perform logical and/or mathematical operations based, at least in part on, or indicated by, training and/or inference code (e.g., graph code), a result of which may produce activations (e.g., output values from layers or neurons within a neural network) stored in an activation storage 620 that are functions of input/output and/or weight parameter data stored in code and/or data storage 601 and/or code and/or data storage 605. In at least one embodiment, activations stored in activation storage 620 are generated according to linear algebraic and or matrix-based mathematics performed by ALU(s) 610 in response to performing instructions or other code, wherein weight values stored in code and/or data storage 605 and/or data storage 601 are used as operands along with other values, such as bias values, gradient information, momentum values, or other parameters or hyperparameters, any or all of which may be stored in code and/or data storage 605 or code and/or data storage 601 or another storage on or off-chip.

In at least one embodiment, ALU(s) 610 are included within one or more processors or other hardware logic devices or circuits, whereas in another embodiment, ALU(s) 610 may be external to a processor or other hardware logic device or circuit that uses them (e.g., a co-processor). In at least one embodiment, ALUs 610 may be included within a processor's execution units or otherwise within a bank of ALUs accessible by a processor's execution units either within same processor or distributed between different processors of different types (e.g., central processing units, graphics processing units, fixed function units, etc.). In at least one embodiment, code and/or data storage 601, code and/or data storage 605, and activation storage 620 may share a processor or other hardware logic device or circuit, whereas in another embodiment, they may be in different processors or other hardware logic devices or circuits, or some combination of same and different processors or other hardware logic devices or circuits. In at least one embodiment, any portion of activation storage 620 may be included with other on-chip or off-chip data storage, including a processor's L1, L2, or L3 cache or system memory. Furthermore, inferencing and/or training code may be stored with other code accessible to a processor or other hardware logic or circuit and fetched and/or processed using a processor's fetch, decode, scheduling, execution, retirement and/or other logical circuits.

In at least one embodiment, activation storage 620 may be cache memory, DRAM, SRAM, non-volatile memory (e.g., flash memory), or other storage. In at least one embodiment, activation storage 620 may be completely or partially within or external to one or more processors or other logical circuits. In at least one embodiment, a choice of whether activation storage 620 is internal or external to a processor, for example, or including DRAM, SRAM, flash memory or some other storage type may depend on available storage on-chip versus off-chip, latency requirements of training and/or inferencing functions being performed, batch size of data used in inferencing and/or training of a neural network, or some combination of these factors.

In at least one embodiment, logic 615 illustrated in FIG. 6A may be used in conjunction with an application-specific integrated circuit (“ASIC”), such as a TensorFlow® Processing Unit from Google, an inference processing unit (IPU) from Graphcore™, or a Nervana® (e.g., “Lake Crest”) processor from Intel Corp. In at least one embodiment, logic 615 illustrated in FIG. 6A may be used in conjunction with central processing unit (“CPU”) hardware, graphics processing unit (“GPU”) hardware or other hardware, such as field programmable gate arrays (“FPGAs”).

FIG. 6B illustrates logic 615, according to at least one embodiment. In at least one embodiment, logic 615 is inference and/or training logic. In at least one embodiment, logic 615 may include, without limitation, hardware logic in which computational resources are dedicated or otherwise exclusively used in conjunction with weight values or other information corresponding to one or more layers of neurons within a neural network. In at least one embodiment, logic 615 illustrated in FIG. 6B may be used in conjunction with an application-specific integrated circuit (ASIC), such as TensorFlow® Processing Unit from Google, an inference processing unit (IPU) from Graphcore™, or a Nervana® (e.g., “Lake Crest”) processor from Intel Corp. In at least one embodiment, logic 615 illustrated in FIG. 6B may be used in conjunction with central processing unit (CPU) hardware, graphics processing unit (GPU) hardware or other hardware, such as field programmable gate arrays (FPGAs). In at least one embodiment, logic 615 includes, without limitation, code and/or data storage 601 and code and/or data storage 605, which may be used to store code (e.g., graph code), weight values and/or other information, including bias values, gradient information, momentum values, and/or other parameter or hyperparameter information. In at least one embodiment illustrated in FIG. 6B, each of code and/or data storage 601 and code and/or data storage 605 is associated with a dedicated computational resource, such as computational hardware 602 and computational hardware 606, respectively. In at least one embodiment, each of computational hardware 602 and computational hardware 606 includes one or more ALUs that perform mathematical functions, such as linear algebraic functions, only on information stored in code and/or data storage 601 and code and/or data storage 605, respectively, result of which is stored in activation storage 620.

In at least one embodiment, each of code and/or data storage 601 and 605 and corresponding computational hardware 602 and 606, respectively, correspond to different layers of a neural network, such that resulting activation from one storage/computational pair 601/602 of code and/or data storage 601 and computational hardware 602 is provided as an input to a next storage/computational pair 605/606 of code and/or data storage 605 and computational hardware 606, in order to mirror a conceptual organization of a neural network. In at least one embodiment, each of storage/computational pairs 601/602 and 605/606 may correspond to more than one neural network layer. In at least one embodiment, additional storage/computation pairs (not shown) subsequent to or in parallel with storage/computation pairs 601/602 and 605/606 may be included in logic 615.

The components of the system 100, such as the processor(s) 102 and the memory device 120 may be used to implement the logic and hardware structures 615 of FIGS. 6A-6B. In at least one embodiment, at least a portion of system(s) depicted in and/or described with respect to FIGS. 6A and/or 6B is used to implement one or more systems, techniques, functions, and/or processes described in connection with FIGS. 1-5B. For example, in at least one embodiment, at least one component shown or described with respect to depicted in FIGS. 6A and/or 6B is used to automatically scale a telemetry streaming pipeline (up and down) in accordance with one or more techniques, functions, and/or processes described with respect to any of FIGS. 1-5B. In at least one embodiment, one or more systems depicted in or described with respect to FIGS. 6A and/or 6B are utilized to perform operations discussed herein such as those described herein with respect to the registration application 130, the analysis application 132, the method 400, the registration application module 526, the analysis application module 528, API(s) 510, and/or to perform other operations described herein.

### Data Center

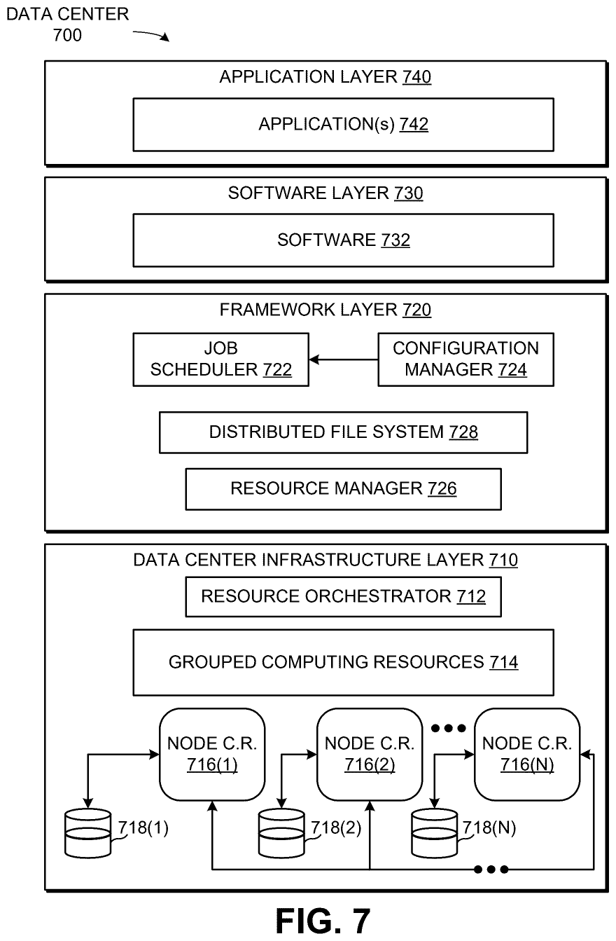

FIG. 7 illustrates an example data center 700, in which at least one embodiment may be used. In at least one embodiment, data center 700 includes a data center infrastructure layer 710, a framework layer 720, a software layer 730 and an application layer 740.

In at least one embodiment, as shown in FIG. 7, data center infrastructure layer 710 may include a resource orchestrator 712, grouped computing resources 714, and node computing resources (“node C.R.s”) 716(1)-716(N), where “N” represents a positive integer (which may be a different integer “N” than used in other figures). In at least one embodiment, node C.R.s 716(1)-716(N) may include, but are not limited to, any number of central processing units (“CPUs”) or other processors (including accelerators, field programmable gate arrays (FPGAs), graphics processors, etc.), memory storage devices 718(1)-718(N) (e.g., dynamic read-only memory, solid state storage or disk drives), network input/output (“NW I/O”) devices, network switches, virtual machines (“VMs”), power modules, and cooling modules, etc. In at least one embodiment, one or more node C.R.s from among node C.R.s 716(1)-716(N) may be a server having one or more of above-mentioned computing resources.

In at least one embodiment, grouped computing resources 714 may include separate groupings of node C.R.s housed within one or more racks (not shown), or many racks housed in data centers at various geographical locations (also not shown). In at least one embodiment, separate groupings of node C.R.s within grouped computing resources 714 may include grouped compute, network, memory or storage resources that may be configured or allocated to support one or more workloads. In at least one embodiment, several node C.R.s including CPUs or processors may be grouped within one or more racks to provide compute resources to support one or more workloads. In at least one embodiment, one or more racks may also include any number of power modules, cooling modules, and network switches, in any combination.

In at least one embodiment, resource orchestrator 712 may configure or otherwise control one or more node C.R.s 716(1)-716(N) and/or grouped computing resources 714. In at least one embodiment, resource orchestrator 712 may include a software design infrastructure (“SDI”) management entity for data center 700. In at least one embodiment, resource orchestrator 712 may include hardware, software or some combination thereof.

In at least one embodiment, as shown in FIG. 7, framework layer 720 includes a job scheduler 722, a configuration manager 724, a resource manager 726 and a distributed file system 728. In at least one embodiment, framework layer 720 may include a framework to support software 732 of software layer 730 and/or one or more application(s) 742 of application layer 740. In at least one embodiment, software 732 or application(s) 742 may respectively include web-based service software or applications, such as those provided by Amazon Web Services, Google Cloud and Microsoft Azure. In at least one embodiment, framework layer 720 may be, but is not limited to, a type of free and open-source software web application framework such as Apache Spark™ (hereinafter “Spark”) that may utilize distributed file system 728 for large-scale data processing (e.g., “big data”). In at least one embodiment, job scheduler 722 may include a Spark driver to facilitate scheduling of workloads supported by various layers of data center 700. In at least one embodiment, configuration manager 724 may be capable of configuring different layers such as software layer 730 and framework layer 720 including Spark and distributed file system 728 for supporting large-scale data processing. In at least one embodiment, resource manager 726 may be capable of managing clustered or grouped computing resources mapped to or allocated for support of distributed file system 728 and job scheduler 722. In at least one embodiment, clustered or grouped computing resources may include grouped computing resources 714 at data center infrastructure layer 710. In at least one embodiment, resource manager 726 may coordinate with resource orchestrator 712 to manage these mapped or allocated computing resources.

In at least one embodiment, software 732 included in software layer 730 may include software used by at least portions of node C.R.s 716(1)-716(N), grouped computing resources 714, and/or distributed file system 728 of framework layer 720. In at least one embodiment, one or more types of software may include, but are not limited to, Internet web page search software, e-mail virus scan software, database software, and streaming video content software.

In at least one embodiment, application(s) 742 included in application layer 740 may include one or more types of applications used by at least portions of node C.R.s 716(1)-716(N), grouped computing resources 714, and/or distributed file system 728 of framework layer 720. In at least one embodiment, one or more types of applications may include, but are not limited to, any number of a genomics application, a cognitive compute, application and a machine learning application, including training or inferencing software, machine learning framework software (e.g., PyTorch, TensorFlow, Caffe, etc.) or other machine learning applications used in conjunction with one or more embodiments.

In at least one embodiment, any of configuration manager 724, resource manager 726, and resource orchestrator 712 may implement any number and type of self-modifying actions based on any amount and type of data acquired in any technically feasible fashion. In at least one embodiment, self-modifying actions may relieve a data center operator of data center 700 from making possibly bad configuration decisions and possibly avoiding underutilized and/or poor performing portions of a data center.

In at least one embodiment, data center 700 may include tools, services, software or other resources to train one or more machine learning models or predict or infer information using one or more machine learning models according to one or more embodiments described herein. For example, in at least one embodiment, a machine learning model may be trained by calculating weight parameters according to a neural network architecture using software and computing resources described above with respect to data center 700. In at least one embodiment, trained machine learning models corresponding to one or more neural networks may be used to infer or predict information using resources described above with respect to data center 700 by using weight parameters calculated through one or more training techniques described herein.

In at least one embodiment, data center may use CPUs, application-specific integrated circuits (ASICs), GPUs, FPGAs, or other hardware to perform training and/or inferencing using above-described resources. Moreover, one or more software and/or hardware resources described above may be configured as a service to allow users to train or performing inferencing of information, such as image recognition, speech recognition, or other artificial intelligence services.

Logic 615 are used to perform inferencing and/or training operations associated with one or more embodiments. Details regarding logic 615 are provided herein in conjunction with FIGS. 6A and/or 6B. In at least one embodiment, logic 615 may be used in data center 700 for inferencing or predicting operations based, at least in part, on weight parameters calculated using neural network training operations, neural network functions and/or architectures, or neural network use cases described herein.

In at least one embodiment, the data center 700 may implement the data lake 134 of FIG. 1. The telemetry stream(s) from the various downstream nodes are provided to the data lake 134, which collects the telemetry data for use by AI and ML analytics, and in advanced computational processes. In at least one embodiment, individual nodes illustrated in FIGS. 2 and 3 could also be implemented using the hardware and logic structure illustrated in FIG. 7. In at least one embodiment, at least a portion of system(s) depicted in and/or described with respect to FIG. 7 is used to implement one or more systems, techniques, functions, and/or processes described in connection with FIGS. 1-5B. For example, in at least one embodiment, at least one component shown or described with respect to depicted in FIG. 7 is used to automatically scale a telemetry streaming pipeline (up and down) in accordance with one or more techniques, functions, and/or processes described with respect to any of FIGS. 1-5B. In at least one embodiment, one or more systems depicted in or described with respect to FIG. 7 are utilized to perform operations discussed herein such as those described herein with respect to the registration application 130, the analysis application 132, the method 400, the registration application module 526, the analysis application module 528, API(s) 510, and/or to perform other operations described herein.

### Computer Systems

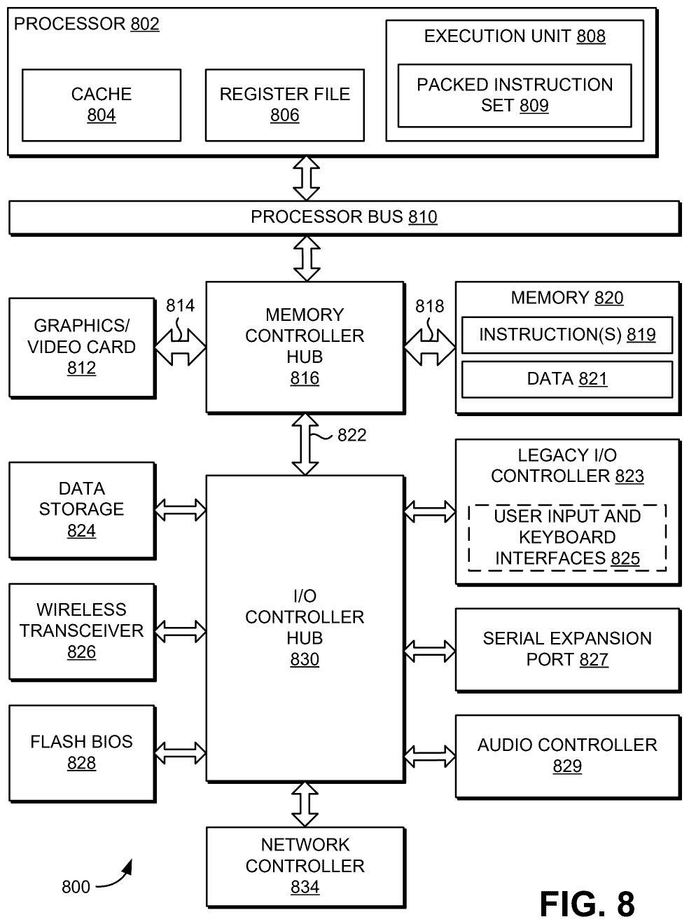

FIG. 8 is a block diagram illustrating an exemplary computer system, which may be a system with interconnected devices and components, a system-on-a-chip (SOC) or some combination thereof formed with a processor that may include execution units to execute an instruction, according to at least one embodiment. In at least one embodiment, a computer system 800 may include, without limitation, a component, such as a processor 802 to employ execution units including logic to perform algorithms for process data, in accordance with present disclosure, such as in embodiment described herein. In at least one embodiment, computer system 800 may include processors, such as PENTIUM® Processor family, Xeon™, Itanium®, XScale™ and/or StrongARM™, Intel® Core™, or Intel® Nervana™ microprocessors available from Intel Corporation of Santa Clara, California, although other systems (including PCs having other microprocessors, engineering workstations, set-top boxes and like) may also be used. In at least one embodiment, computer system 800 may execute a version of WINDOWS operating system available from Microsoft Corporation of Redmond, Wash., although other operating systems (UNIX and Linux, for example), embedded software, and/or graphical user interfaces, may also be used.

Embodiments may be used in other devices such as handheld devices and embedded applications. Some examples of handheld devices include cellular phones, Internet Protocol devices, digital cameras, personal digital assistants (“PDAs”), and handheld PCs. In at least one embodiment, embedded applications may include a microcontroller, a digital signal processor (“DSP”), system on a chip, network computers (“NetPCs”), set-top boxes, network hubs, wide area network (“WAN”) switches, or any other system that may perform one or more instructions in accordance with at least one embodiment.

In at least one embodiment, computer system 800 may include, without limitation, processor 802 that may include, without limitation, one or more execution units 808 to perform machine learning model training and/or inferencing according to techniques described herein. In at least one embodiment, computer system 800 is a single processor desktop or server system, but in another embodiment, computer system 800 may be a multiprocessor system. In at least one embodiment, processor 802 may include, without limitation, a complex instruction set computer (“CISC”) microprocessor, a reduced instruction set computing (“RISC”) microprocessor, a very long instruction word (“VLIW”) microprocessor, a processor implementing a combination of instruction sets, or any other processor device, such as a digital signal processor, for example. In at least one embodiment, processor 802 may be coupled to a processor bus 810 that may transmit data signals between processor 802 and other components in computer system 800.

In at least one embodiment, processor 802 may include, without limitation, a Level 1 (“L1”) internal cache memory (“cache”) 804. In at least one embodiment, processor 802 may have a single internal cache or multiple levels of internal cache. In at least one embodiment, cache memory may reside external to processor 802. Other embodiments may also include a combination of both internal and external caches depending on particular implementation and needs. In at least one embodiment, a register file 806 may store different types of data in various registers including, without limitation, integer registers, floating point registers, status registers, and an instruction pointer register.

In at least one embodiment, execution unit 808, including, without limitation, logic to perform integer and floating point operations, also resides in processor 802. In at least one embodiment, processor 802 may also include a microcode (“ucode”) read only memory (“ROM”) that stores microcode for certain macro instructions. In at least one embodiment, execution unit 808 may include logic to handle a packed instruction set 809. In at least one embodiment, by including packed instruction set 809 in an instruction set of a general-purpose processor, along with associated circuitry to execute instructions, operations used by many multimedia applications may be performed using packed data in processor 802. In at least one embodiment, many multimedia applications may be accelerated and executed more efficiently by using a full width of a processor's data bus for performing operations on packed data, which may eliminate a need to transfer smaller units of data across that processor's data bus to perform one or more operations one data element at a time.

In at least one embodiment, execution unit 808 may also be used in microcontrollers, embedded processors, graphics devices, DSPs, and other types of logic circuits. In at least one embodiment, computer system 800 may include, without limitation, a memory 820. In at least one embodiment, memory 820 may be a Dynamic Random Access Memory (“DRAM”) device, a Static Random Access Memory (“SRAM”) device, a flash memory device, or another memory device. In at least one embodiment, memory 820 may store instruction(s) 819 and/or data 821 represented by data signals that may be executed by processor 802.

In at least one embodiment, a system logic chip may be coupled to processor bus 810 and memory 820. In at least one embodiment, a system logic chip may include, without limitation, a memory controller hub (“MCH”) 816, and processor 802 may communicate with MCH 816 via processor bus 810. In at least one embodiment, MCH 816 may provide a high bandwidth memory path 818 to memory 820 for instruction and data storage and for storage of graphics commands, data and textures. In at least one embodiment, MCH 816 may direct data signals between processor 802, memory 820, and other components in computer system 800 and to bridge data signals between processor bus 810, memory 820, and a system I/O interface 822. In at least one embodiment, a system logic chip may provide a graphics port for coupling to a graphics controller. In at least one embodiment, MCH 816 may be coupled to memory 820 through high bandwidth memory path 818 and a graphics/video card 812 may be coupled to MCH 816 through an Accelerated Graphics Port (“AGP”) interconnect 814.

In at least one embodiment, computer system 800 may use system I/O interface 822 as a proprietary hub interface bus to couple MCH 816 to an I/O controller hub (“ICH”) 830. In at least one embodiment, ICH 830 may provide direct connections to some I/O devices via a local I/O bus. In at least one embodiment, a local I/O bus may include, without limitation, a high-speed I/O bus for connecting peripherals to memory 820, a chipset, and processor 802. Examples may include, without limitation, an audio controller 829, a firmware hub (“flash BIOS”) 828, a wireless transceiver 826, a data storage 824, a legacy I/O controller 823 containing user input and keyboard interfaces 825, a serial expansion port 827, such as a Universal Serial Bus (“USB”) port, and a network controller 834. In at least one embodiment, data storage 824 may include a hard disk drive, a floppy disk drive, a CD-ROM device, a flash memory device, or other mass storage device.

In at least one embodiment, FIG. 8 illustrates a system, which includes interconnected hardware devices or “chips”, whereas in other embodiments, FIG. 8 may illustrate an exemplary SoC. In at least one embodiment, devices illustrated in FIG. 8 may be interconnected with proprietary interconnects, standardized interconnects (e.g., PCIe) or some combination thereof. In at least one embodiment, one or more components of computer system 800 are interconnected using compute express link (CXL) interconnects.

Logic 615 are used to perform inferencing and/or training operations associated with one or more embodiments. Details regarding logic 615 are provided herein in conjunction with FIGS. 6A and/or 6B. In at least one embodiment, logic 615 may be used in computer system 800 for inferencing or predicting operations based, at least in part, on weight parameters calculated using neural network training operations, neural network functions and/or architectures, or neural network use cases described herein.

In at least one embodiment, the computer system 800 may implement the system 100 of FIG. 1. In at least one embodiment, individual nodes illustrated in FIGS. 2-3 could also be implemented using the hardware and software illustrated in FIG. 8. In at least one embodiment, at least a portion of system(s) depicted in and/or described with respect to FIG. 8 is used to implement one or more systems, techniques, functions, and/or processes described in connection with FIGS. 1-5B. For example, in at least one embodiment, at least one component shown or described with respect to depicted in FIG. 8 is used to automatically scale a telemetry streaming pipeline (up and down) in accordance with one or more techniques, functions, and/or processes described with respect to any of FIGS. 1-5B. In at least one embodiment, one or more systems depicted in or described with respect to FIG. 8 are utilized to perform operations discussed herein such as those described herein with respect to the registration application 130, the analysis application 132, the method 400, the registration application module 526, the analysis application module 528, API(s) 510, and/or to perform other operations described herein.

At least one embodiment of the disclosure can be described in view of the following clauses:

1. A system comprising: a plurality of network devices to transmit one or more telemetry streams, a first of the plurality of network devices to transmit telemetry data to a second of the plurality of network devices, the second network device to modify at least one operation to be performed by the second network device with respect to at least one of the one or more telemetry streams, based at least in part on the received telemetry data.

2. The system of clause 1, wherein the plurality of network devices comprise a telemetry streaming pipeline, and a portion of the telemetry streaming pipeline is to be modified by modifying the at least one operation to be performed by the second network device.

3. The system of clause 1 or 2, wherein the second network device is to communicate a particular one of the one or more telemetry streams with the first network device, the second network device is to create a record that associates the first network device with the particular telemetry stream, and the at least one operation to be performed by the second network device is to be modified based at least part on the record.

4. The system of any one of clauses 1-3, wherein the telemetry data comprises data related to changes in bandwidth capabilities of the first network device.

5. The system of any one of clauses 1-4, wherein the telemetry data is first telemetry data, the at least one telemetry stream comprises a first telemetry stream, the second network device is to stream the first telemetry stream to the first network device, a third network device of the plurality of network devices is to stream the first telemetry stream to the second network device, the second network device to transmit second telemetry data to the third network device, and the third network device to modify at least one operation to be performed by the third network device with respect to the first telemetry stream based at least in part on the received second telemetry data.

6. The system of clause 5, wherein the second network device is to transmit the second telemetry data to the first network device.

7. The system of clause 5 or 6, wherein the second telemetry data is based at least in part on the first telemetry data.

8. The system of any one of clauses 5-7, wherein the third network device is to transmit third telemetry data to the first and second network devices, and third telemetry data is to be based at least in part on modifying the at least one operation to be performed by the third network device with respect to the first telemetry stream.

9. The system of clause 8, wherein the third telemetry data transmitted by the third network device comprises data related to changes in bandwidth capabilities of the third network device.

10. The system of any one of clauses 5-9, wherein the second network device receives third telemetry data from a fourth network device of the plurality of network devices, and the second telemetry data is based at least part on a combination of the first telemetry data and the third telemetry data.

11. The system of any one of clauses 5-10, wherein the first network device is to stream a second one of the one or more telemetry streams to a fourth network device of the plurality of network devices, and the first network device is to transmit the first telemetry data to the fourth network device.

12. A method comprising: transmitting, by a first network device, telemetry data to a second network device; and modifying, by the second network device, at least one operation of the second network device with respect to at least one telemetry stream being transmitted from the second network device to the first network device based at least in part on the received telemetry data.

13. The method of clause 12, wherein the plurality of network devices comprise a telemetry streaming pipeline, and a portion of the telemetry streaming pipeline is to be modified by modifying the at least one operation to be performed by the second network device.

14. The method of clause 12 or 13, wherein the second network device is to communicate a particular one of the one or more telemetry streams with the first network device, the second network device is to create a record that associates the first network device with the particular telemetry stream, and the at least one operation to be performed by the second network device is to be modified based at least part on the record.

15. The method of any one of clauses 12-14, wherein the telemetry data is first telemetry data, the at least one telemetry stream comprises a first telemetry stream, the second network device is to stream the first telemetry stream to the first network device, a third network device of the plurality of network devices is to stream the first telemetry stream to the second network device, the second network device to transmit second telemetry data to the third network device, and the third network device to modify at least one operation to be performed by the third network device with respect to the first telemetry stream based at least in part on the received second telemetry data.

16. The method of clause 15, wherein the second network device transmits the second telemetry data to the first network device.

17. The method of clause 15 or 16, wherein the second telemetry data is based at least in part on the first telemetry data.

18. The method of any one of clauses 15-17, wherein the third network device is to transmit third telemetry data to the first and second network devices, and third telemetry data is to be based at least in part on modifying the at least one operation to be performed by the third network device with respect to the first telemetry stream.

19. The method of any one of clauses 15-18, wherein the second network device receives third telemetry data from a fourth network device of the plurality of network devices, and the second telemetry data is based at least part on a combination of the first telemetry data and the third telemetry data.

20. The method of any one of clauses 15-19, wherein the first network device is to stream a second one of the one or more telemetry streams to a fourth network device of the plurality of network devices, and the first network device is to transmit the first telemetry data to the fourth network device.

21. The method of any one of clauses 15-20, wherein the first network device is to stream a second one of the one or more telemetry streams to a fourth network device of the plurality of network devices, and the first network device is to transmit the first telemetry data to the fourth network device.

22. A processor comprising one or more circuits to implement: a plurality of network devices to transmit one or more telemetry streams, a first of the plurality of network devices to transmit telemetry data to a second of the plurality of network devices, the second network device to modify at least one operation to be performed by the second network device with respect to at least one of the one or more telemetry streams, based at least in part on the received telemetry data.

23. The processor of clause 22, wherein the plurality of network devices comprise a telemetry streaming pipeline, and a portion of the telemetry streaming pipeline is to be modified by modifying the at least one operation to be performed by the second network device.

24. The processor of clause 22 or 23, wherein the second network device is to communicate a particular one of the one or more telemetry streams with the first network device, the second network device is to create a record that associates the first network device with the particular telemetry stream, and the at least one operation to be performed by the second network device is to be modified based at least part on the record.

25. The processor of any one of clauses 22-24, wherein the telemetry data comprises data related to changes in bandwidth capabilities of the first network device.

26. The processor of any one of clauses 22-25, wherein the telemetry data is first telemetry data, the at least one telemetry stream comprises a first telemetry stream, the second network device is to stream the first telemetry stream to the first network device, a third network device of the plurality of network devices is to stream the first telemetry stream to the second network device, the second network device to transmit second telemetry data to the third network device, and the third network device to modify at least one operation to be performed by the third network device with respect to the first telemetry stream based at least in part on the received second telemetry data.

27. The processor of clause 26, wherein the second network device is to transmit the second telemetry data to the first network device.

28. The processor of clause 26 or 27, wherein the second telemetry data is based at least in part on the first telemetry data.

29. The processor of any one of clause 26-28, wherein the third network device is to transmit third telemetry data to the first and second network devices, and third telemetry data is to be based at least in part on modifying the at least one operation to be performed by the third network device with respect to the first telemetry stream.

30. The processor of clause 29, wherein the third telemetry data transmitted by the third network device comprises data related to changes in bandwidth capabilities of the third network device.

31. The processor of any one of clauses 26-30, wherein the second network device receives third telemetry data from a fourth network device of the plurality of network devices, and the second telemetry data is based at least part on a combination of the first telemetry data and the third telemetry data.

32. The processor of any one of clause 26-31, wherein the first network device is to stream a second one of the one or more telemetry streams to a fourth network device of the plurality of network devices, and the first network device is to transmit the first telemetry data to the fourth network device.

In at least one embodiment, a single semiconductor platform may refer to a sole unitary semiconductor-based integrated circuit or chip. In at least one embodiment, multi-chip modules may be used with increased connectivity which simulate on-chip operation, and make substantial improvements over utilizing a conventional central processing unit (“CPU”) and bus implementation. In at least one embodiment, various modules may also be situated separately or in various combinations of semiconductor platforms per desires of user.

In at least one embodiment, computer programs in form of machine-readable executable code or computer control logic algorithms are stored in main memory and/or secondary storage such as those described herein. Computer programs, if executed by one or more processors, enable at least one system described herein to perform various functions in accordance with at least one embodiment. In at least one embodiment, memory, storage, and/or any other storage are possible examples of computer-readable media. In at least one embodiment, secondary storage may refer to any suitable storage device or system such as a hard disk drive and/or a removable storage drive, representing a floppy disk drive, a magnetic tape drive, a compact disk drive, digital versatile disk (“DVD”) drive, recording device, universal serial bus (“USB”) flash memory, etc. In at least one embodiment, architecture and/or functionality of various previous figures are implemented in context of a CPU such as those described herein, a parallel processing system such as those described herein, an integrated circuit capable of at least a portion of capabilities of both the CPU, the parallel processing system, a chipset (e.g., a group of integrated circuits designed to work and sold as a unit for performing related functions, etc.), and/or any suitable combination of integrated circuit(s).

In at least one embodiment, architecture and/or functionality of various previous figures are implemented in context of a general computer system, a circuit board system, a game console system dedicated for entertainment purposes, an application-specific system, and more. In at least one embodiment, a computer system described herein may take form of a desktop computer, a laptop computer, a tablet computer, servers, supercomputers, a smart-phone (e.g., a wireless, hand-held device), personal digital assistant (“PDA”), a digital camera, a vehicle, a head mounted display, a hand-held electronic device, a mobile phone device, a television, workstation, game consoles, embedded system, and/or any other type of logic. In at least one embodiment, a computer system includes or refers to any devices illustrated in any of the drawings and/or described herein.

In at least one embodiment, a parallel processing system includes, without limitation, a plurality of parallel processing units (“PPUs”) and associated memories. In at least one embodiment, PPUs are connected to a host processor or other peripheral devices via an interconnect and a switch or multiplexer. In at least one embodiment, a parallel processing system distributes computational tasks across the PPUs, which can be parallelizable—for example, as part of distribution of computational tasks across multiple graphics processing unit (“GPU”) thread blocks. In at least one embodiment, memory is shared and accessible (e.g., for read and/or write access) across some or all of the PPUs, although such shared memory may incur performance penalties relative to use of local memory and registers resident to a PPU. In at least one embodiment, operation of the PPUs is synchronized through use of a command such as _syncthreads ( ) wherein all threads in a block (e.g., executed across multiple PPUs) to reach a certain point of execution of code before proceeding.

In at least one embodiment, one or more techniques described herein utilize a oneAPI programming model. In at least one embodiment, a oneAPI programming model refers to a programming model for interacting with various compute accelerator architectures. In at least one embodiment, oneAPI refers to an application programming interface (API) designed to interact with various compute accelerator architectures. In at least one embodiment, a oneAPI programming model utilizes a DPC++ programming language. In at least one embodiment, a DPC++ programming language refers to a high-level language for data parallel programming productivity. In at least one embodiment, a DPC++ programming language is based at least in part on C and/or C++ programming languages. In at least one embodiment, a oneAPI programming model is a programming model such as those developed by Intel Corporation of Santa Clara, CA.

In at least one embodiment, oneAPI and/or oneAPI programming model is utilized to interact with various accelerator, GPU, processor, and/or variations thereof, architectures. In at least one embodiment, oneAPI includes a set of libraries that implement various functionalities. In at least one embodiment, oneAPI includes at least a oneAPI DPC++ library, a oneAPI math kernel library, a oneAPI data analytics library, a oneAPI deep neural network library, a oneAPI collective communications library, a oneAPI threading building blocks library, a oneAPI video processing library, and/or variations thereof.

In at least one embodiment, a oneAPI DPC++ library, also referred to as oneDPL, is a library that implements algorithms and functions to accelerate DPC++ kernel programming. In at least one embodiment, oneDPL implements one or more standard template library (STL) functions. In at least one embodiment, oneDPL implements one or more parallel STL functions. In at least one embodiment, oneDPL provides a set of library classes and functions such as parallel algorithms, iterators, function object classes, range-based API, and/or variations thereof. In at least one embodiment, oneDPL implements one or more classes and/or functions of a C++ standard library. In at least one embodiment, oneDPL implements one or more random number generator functions.

In at least one embodiment, a oneAPI math kernel library, also referred to as oneMKL, is a library that implements various optimized and parallelized routines for various mathematical functions and/or operations. In at least one embodiment, oneMKL implements one or more basic linear algebra subprograms (BLAS) and/or linear algebra package (LAPACK) dense linear algebra routines. In at least one embodiment, oneMKL implements one or more sparse BLAS linear algebra routines. In at least one embodiment, oneMKL implements one or more random number generators (RNGs). In at least one embodiment, oneMKL implements one or more vector mathematics (VM) routines for mathematical operations on vectors. In at least one embodiment, oneMKL implements one or more Fast Fourier Transform (FFT) functions.

In at least one embodiment, a oneAPI data analytics library, also referred to as oneDAL, is a library that implements various data analysis applications and distributed computations. In at least one embodiment, oneDAL implements various algorithms for preprocessing, transformation, analysis, modeling, validation, and decision making for data analytics, in batch, online, and distributed processing modes of computation. In at least one embodiment, oneDAL implements various C++ and/or Java APIs and various connectors to one or more data sources. In at least one embodiment, oneDAL implements DPC++ API extensions to a traditional C++ interface and enables GPU usage for various algorithms.

In at least one embodiment, a oneAPI deep neural network library, also referred to as oneDNN, is a library that implements various deep learning functions. In at least one embodiment, oneDNN implements various neural network, machine learning, and deep learning functions, algorithms, and/or variations thereof.

In at least one embodiment, a oneAPI collective communications library, also referred to as oneCCL, is a library that implements various applications for deep learning and machine learning workloads. In at least one embodiment, oneCCL is built upon lower-level communication middleware, such as message passing interface (MPI) and libfabrics. In at least one embodiment, oneCCL enables a set of deep learning specific optimizations, such as prioritization, persistent operations, out of order executions, and/or variations thereof. In at least one embodiment, oneCCL implements various CPU and GPU functions.

In at least one embodiment, a oneAPI threading building blocks library, also referred to as oneTBB, is a library that implements various parallelized processes for various applications. In at least one embodiment, oneTBB is utilized for task-based, shared parallel programming on a host. In at least one embodiment, oneTBB implements generic parallel algorithms. In at least one embodiment, oneTBB implements concurrent containers. In at least one embodiment, oneTBB implements a scalable memory allocator. In at least one embodiment, oneTBB implements a work-stealing task scheduler. In at least one embodiment, oneTBB implements low-level synchronization primitives. In at least one embodiment, oneTBB is compiler-independent and usable on various processors, such as GPUs, PPUs, CPUs, and/or variations thereof.

In at least one embodiment, a oneAPI video processing library, also referred to as oneVPL, is a library that is utilized for accelerating video processing in one or more applications. In at least one embodiment, oneVPL implements various video decoding, encoding, and processing functions. In at least one embodiment, one VPL implements various functions for media pipelines on CPUs, GPUs, and other accelerators. In at least one embodiment, one VPL implements device discovery and selection in media centric and video analytics workloads. In at least one embodiment, one VPL implements API primitives for zero-copy buffer sharing.

In at least one embodiment, a oneAPI programming model utilizes a DPC++ programming language. In at least one embodiment, a DPC++ programming language is a programming language that includes, without limitation, functionally similar versions of CUDA mechanisms to define device code and distinguish between device code and host code. In at least one embodiment, a DPC++ programming language may include a subset of functionality of a CUDA programming language. In at least one embodiment, one or more CUDA programming model operations are performed using a oneAPI programming model using a DPC++ programming language.

In at least one embodiment, any application programming interface (API) described herein is compiled into one or more instructions, operations, or any other signal by a compiler, interpreter, or other software tool. In at least one embodiment, compilation includes generating one or more machine-executable instructions, operations, or other signals from source code. In at least one embodiment, an API compiled into one or more instructions, operations, or other signals, when performed, causes one or more processors, such as graphics processors, graphics cores, parallel processor, a CPU, or any other logic circuit further described herein to perform one or more computing operations.

It should be noted that, while example embodiments described herein may relate to a CUDA programming model, techniques described herein can be utilized with any suitable programming model, such HIP, oneAPI, and/or variations thereof.

Other variations are within spirit of present disclosure. Thus, while disclosed techniques are susceptible to various modifications and alternative constructions, certain illustrated embodiments thereof are shown in drawings and have been described above in detail. It should be understood, however, that there is no intention to limit disclosure to specific form or forms disclosed, but on contrary, intention is to cover all modifications, alternative constructions, and equivalents falling within spirit and scope of disclosure, as defined in appended claims.

Use of terms “a” and “an” and “the” and similar referents in context of describing disclosed embodiments (especially in context of following claims) are to be construed to cover both singular and plural, unless otherwise indicated herein or clearly contradicted by context, and not as a definition of a term. Terms “comprising,” “having,” “including,” and “containing” are to be construed as open-ended terms (meaning “including, but not limited to,”) unless otherwise noted. “Connected,” when unmodified and referring to physical connections, is to be construed as partly or wholly contained within, attached to, or joined together, even if there is something intervening. Recitation of ranges of values herein are merely intended to serve as a shorthand method of referring individually to each separate value falling within range, unless otherwise indicated herein and each separate value is incorporated into specification as if it were individually recited herein. In at least one embodiment, use of term “set” (e.g., “a set of items”) or “subset” unless otherwise noted or contradicted by context, is to be construed as a nonempty collection comprising one or more members. Further, unless otherwise noted or contradicted by context, term “subset” of a corresponding set does not necessarily denote a proper subset of corresponding set, but subset and corresponding set may be equal.

Conjunctive language, such as phrases of form “at least one of A, B, and C,” or “at least one of A, B and C,” unless specifically stated otherwise or otherwise clearly contradicted by context, is otherwise understood with context as used in general to present that an item, term, etc., may be either A or B or C, or any nonempty subset of set of A and B and C. For instance, in illustrative example of a set having three members, conjunctive phrases “at least one of A, B, and C” and “at least one of A, B and C” refer to any of following sets: {A}, {B}, {C}, {A, B}, {A, C}, {B, C}, {A, B, C}. Thus, such conjunctive language is not generally intended to imply that certain embodiments require at least one of A, at least one of B and at least one of C each to be present. In addition, unless otherwise noted or contradicted by context, term “plurality” indicates a state of being plural (e.g., “a plurality of items” indicates multiple items). In at least one embodiment, number of items in a plurality is at least two, but can be more when so indicated either explicitly or by context. Further, unless stated otherwise or otherwise clear from context, phrase “based on” means “based at least in part on” and not “based solely on.”

Operations of processes described herein can be performed in any suitable order unless otherwise indicated herein or otherwise clearly contradicted by context. In at least one embodiment, a process such as those processes described herein (or variations and/or combinations thereof) is performed under control of one or more computer systems configured with executable instructions and is implemented as code (e.g., executable instructions, one or more computer programs or one or more applications) executing collectively on one or more processors, by hardware or combinations thereof. In at least one embodiment, code is stored on a computer-readable storage medium, for example, in form of a computer program comprising a plurality of instructions executable by one or more processors. In at least one embodiment, a computer-readable storage medium is a non-transitory computer-readable storage medium that excludes transitory signals (e.g., a propagating transient electric or electromagnetic transmission) but includes non-transitory data storage circuitry (e.g., buffers, cache, and queues) within transceivers of transitory signals. In at least one embodiment, code (e.g., executable code or source code) is stored on a set of one or more non-transitory computer-readable storage media having stored thereon executable instructions (or other memory to store executable instructions) that, when executed (i.e., as a result of being executed) by one or more processors of a computer system, cause computer system to perform operations described herein. In at least one embodiment, set of non-transitory computer-readable storage media comprises multiple non-transitory computer-readable storage media and one or more of individual non-transitory storage media of multiple non-transitory computer-readable storage media lack all of code while multiple non-transitory computer-readable storage media collectively store all of code. In at least one embodiment, executable instructions are executed such that different instructions are executed by different processors—for example, a non-transitory computer-readable storage medium store instructions and a main central processing unit (“CPU”) executes some of instructions while a graphics processing unit (“GPU”) executes other instructions. In at least one embodiment, different components of a computer system have separate processors and different processors execute different subsets of instructions.

In at least one embodiment, an arithmetic logic unit is a set of combinational logic circuitry that takes one or more inputs to produce a result. In at least one embodiment, an arithmetic logic unit is used by a processor to implement mathematical operation such as addition, subtraction, or multiplication. In at least one embodiment, an arithmetic logic unit is used to implement logical operations such as logical AND/OR or XOR. In at least one embodiment, an arithmetic logic unit is stateless, and made from physical switching components such as semiconductor transistors arranged to form logical gates. In at least one embodiment, an arithmetic logic unit may operate internally as a stateful logic circuit with an associated clock. In at least one embodiment, an arithmetic logic unit may be constructed as an asynchronous logic circuit with an internal state not maintained in an associated register set. In at least one embodiment, an arithmetic logic unit is used by a processor to combine operands stored in one or more registers of the processor and produce an output that can be stored by the processor in another register or a memory location.

In at least one embodiment, as a result of processing an instruction retrieved by the processor, the processor presents one or more inputs or operands to an arithmetic logic unit, causing the arithmetic logic unit to produce a result based at least in part on an instruction code provided to inputs of the arithmetic logic unit. In at least one embodiment, the instruction codes provided by the processor to the ALU are based at least in part on the instruction executed by the processor. In at least one embodiment combinational logic in the ALU processes the inputs and produces an output which is placed on a bus within the processor. In at least one embodiment, the processor selects a destination register, memory location, output device, or output storage location on the output bus so that clocking the processor causes the results produced by the ALU to be sent to the desired location.

In the scope of this application, the term arithmetic logic unit, or ALU, is used to refer to any computational logic circuit that processes operands to produce a result. For example, in the present document, the term ALU can refer to a floating point unit, a DSP, a tensor core, a shader core, a coprocessor, or a CPU.

In at least one embodiment, one or more components of systems and/or processors disclosed above can communicate with one or more CPUs, ASICs, GPUs, FPGAs, or other hardware, circuitry, or integrated circuit components that include, e.g., an upscaler or upsampler to upscale an image, an image blender or image blender component to blend, mix, or add images together, a sampler to sample an image (e.g., as part of a DSP), a neural network circuit that is configured to perform an upscaler to upscale an image (e.g., from a low resolution image to a high resolution image), or other hardware to modify or generate an image, frame, or video to adjust its resolution, size, or pixels; one or more components of systems and/or processors disclosed above can use components described in this disclosure to perform methods, operations, or instructions that generate or modify an image.

Accordingly, in at least one embodiment, computer systems are configured to implement one or more services that singly or collectively perform operations of processes described herein and such computer systems are configured with applicable hardware and/or software that enable performance of operations. Further, a computer system that implements at least one embodiment of present disclosure is a single device and, in another embodiment, is a distributed computer system comprising multiple devices that operate differently such that distributed computer system performs operations described herein and such that a single device does not perform all operations.

Use of any and all examples, or exemplary language (e.g., “such as”) provided herein, is intended merely to better illuminate embodiments of disclosure and does not pose a limitation on scope of disclosure unless otherwise claimed. No language in specification should be construed as indicating any non-claimed element as essential to practice of disclosure.

All references, including publications, patent applications, and patents, cited herein are hereby incorporated by reference to same extent as if each reference were individually and specifically indicated to be incorporated by reference and were set forth in its entirety herein.

In description and claims, terms “coupled” and “connected,” along with their derivatives, may be used. It should be understood that these terms may be not intended as synonyms for each other. Rather, in particular examples, “connected” or “coupled” may be used to indicate that two or more elements are in direct or indirect physical or electrical contact with each other. “Coupled” may also mean that two or more elements are not in direct contact with each other, but yet still co-operate or interact with each other.

Unless specifically stated otherwise, it may be appreciated that throughout specification terms such as “processing,” “computing,” “calculating,” “determining,” or like, refer to action and/or processes of a computer or computing system, or similar electronic computing device, that manipulate and/or transform data represented as physical, such as electronic, quantities within computing system's registers and/or memories into other data similarly represented as physical quantities within computing system's memories, registers or other such information storage, transmission or display devices.

In a similar manner, term “processor” may refer to any device or portion of a device that processes electronic data from registers and/or memory and transform that electronic data into other electronic data that may be stored in registers and/or memory. As non-limiting examples, “processor” may be a CPU or a GPU. A “computing platform” may comprise one or more processors. As used herein, “software” processes may include, for example, software and/or hardware entities that perform work over time, such as tasks, threads, and intelligent agents. Also, each process may refer to multiple processes, for carrying out instructions in sequence or in parallel, continuously or intermittently. In at least one embodiment, terms “system” and “method” are used herein interchangeably insofar as system may embody one or more methods and methods may be considered a system.

In present document, references may be made to obtaining, acquiring, receiving, or inputting analog or digital data into a subsystem, computer system, or computer-implemented machine. In at least one embodiment, process of obtaining, acquiring, receiving, or inputting analog and digital data can be accomplished in a variety of ways such as by receiving data as a parameter of a function call or a call to an application programming interface. In at least one embodiment, processes of obtaining, acquiring, receiving, or inputting analog or digital data can be accomplished by transferring data via a serial or parallel interface. In at least one embodiment, processes of obtaining, acquiring, receiving, or inputting analog or digital data can be accomplished by transferring data via a computer network from providing entity to acquiring entity. In at least one embodiment, references may also be made to providing, outputting, transmitting, sending, or presenting analog or digital data. In various examples, processes of providing, outputting, transmitting, sending, or presenting analog or digital data can be accomplished by transferring data as an input or output parameter of a function call, a parameter of an application programming interface or interprocess communication mechanism.

Although descriptions herein set forth example implementations of described techniques, other architectures may be used to implement described functionality, and are intended to be within scope of this disclosure. Furthermore, although specific distributions of responsibilities may be defined above for purposes of description, various functions and responsibilities might be distributed and divided in different ways, depending on circumstances.

Furthermore, although subject matter has been described in language specific to structural features and/or methodological acts, it is to be understood that subject matter claimed in appended claims is not necessarily limited to specific features or acts described. Rather, specific features and acts are disclosed as exemplary forms of implementing the claims.

What is claimed is:

1. A system comprising:
a plurality of network devices to transmit one or more telemetry streams, a first of the plurality of network devices to transmit telemetry data to a second of the plurality of network devices, the second network device to modify at least one operation to be performed by the second network device with respect to at least one of the one or more telemetry streams, based at least in part on the received telemetry data.

2. The system of claim 1, wherein the plurality of network devices comprise a telemetry streaming pipeline, and a portion of the telemetry streaming pipeline is to be modified by modifying the at least one operation to be performed by the second network device.

3. The system of claim 1, wherein the second network device is to communicate a particular one of the one or more telemetry streams with the first network device,
the second network device is to create a record that associates the first network device with the particular telemetry stream, and
the at least one operation to be performed by the second network device is to be modified based at least part on the record.

4. The system of claim 1, wherein the second network device is to create a record that associates the first network device with the particular telemetry stream, and
the record is sent by the second network device to each of the plurality of network devices.

5. The system of claim 1, wherein the telemetry data comprises data related to changes in bandwidth capabilities of the first network device.

6. The system of claim 1, wherein the telemetry data is first telemetry data,
the at least one telemetry stream comprises a first telemetry stream,
the second network device is to stream the first telemetry stream to the first network device,
a third network device of the plurality of network devices is to stream the first telemetry stream to the second network device,
the second network device to transmit second telemetry data to the third network device, and
the third network device to modify at least one operation to be performed by the third network device with respect to the first telemetry stream based at least in part on the received second telemetry data.

7. The system of claim 6, wherein the third network device is to transmit third telemetry data to the first and second network devices, and
third telemetry data is to be based at least in part on modifying the at least one operation to be performed by the third network device with respect to the first telemetry stream.

8. The system of claim 7, wherein the third telemetry data transmitted by the third network device comprises data related to changes in bandwidth capabilities of the third network device.

9. The system of claim 6, wherein the second network device receives third telemetry data from a fourth network device of the plurality of network devices, and
the second telemetry data is based at least part on a combination of the first telemetry data and the third telemetry data.

10. The system of claim 6, wherein the first network device is to stream a second one of the one or more telemetry streams to a fourth network device of the plurality of network devices, and
the first network device is to transmit the first telemetry data to the fourth network device.

11. A method comprising:
transmitting, by a first network device, telemetry data to a second network device; and
modifying, by the second network device, at least one operation of the second network device with respect to at least one telemetry stream being transmitted from the second network device to the first network device based at least in part on the received telemetry data.

12. The method of claim 11, wherein the plurality of network devices comprise a telemetry streaming pipeline, and a portion of the telemetry streaming pipeline is to be modified by modifying the at least one operation to be performed by the second network device.

13. The method of claim 11, wherein the telemetry data is first telemetry data,
the at least one telemetry stream comprises a first telemetry stream,
the second network device is to stream the first telemetry stream to the first network device,
a third network device of the plurality of network devices is to stream the first telemetry stream to the second network device,
the second network device to transmit second telemetry data to the third network device, and
the third network device to modify at least one operation to be performed by the third network device with respect to the first telemetry stream based at least in part on the received second telemetry data.

14. The method of claim 13, wherein the second network device transmits the second telemetry data to the first network device.

15. The method of claim 13, wherein the second telemetry data is based at least in part on the first telemetry data.

16. The method of claim 13, wherein the second network device receives third telemetry data from a fourth network device of the plurality of network devices, and
the second telemetry data is based at least part on a combination of the first telemetry data and the third telemetry data.

17. The method of claim 13, wherein the first network device is to stream a second one of the one or more telemetry streams to a fourth network device of the plurality of network devices, and
the first network device is to transmit the first telemetry data to the fourth network device.

18. A processor comprising one or more circuits to implement:
a plurality of network devices to transmit one or more telemetry streams, a first of the plurality of network devices to transmit telemetry data to a second of the plurality of network devices, the second network device to modify at least one operation to be performed by the second network device with respect to at least one of the one or more telemetry streams, based at least in part on the received telemetry data.

19. The processor of claim 18, wherein the plurality of network devices comprise a telemetry streaming pipeline, and a portion of the telemetry streaming pipeline is to be modified by modifying the at least one operation to be performed by the second network device.

20. The processor of claim 18, wherein the second network device is to communicate a particular one of the one or more telemetry streams with the first network device,
the second network device is to create a record that associates the first network device with the particular telemetry stream, and
the at least one operation to be performed by the second network device is to be modified based at least part on the record.

21. The processor of claim 18, wherein the second network device is to create a record that associates the first network device with the particular telemetry stream, and
the record is sent by the second network device to each of the plurality of network devices.

22. The processor of claim 18, wherein the telemetry data is first telemetry data,
the at least one telemetry stream comprises a first telemetry stream,
the second network device is to stream the first telemetry stream to the first network device,
a third network device of the plurality of network devices is to stream the first telemetry stream to the second network device,
the second network device to transmit second telemetry data to the third network device, and
the third network device to modify at least one operation to be performed by the third network device with respect to the first telemetry stream based at least in part on the received second telemetry data.

23. The processor of claim 18, wherein the second telemetry data is based at least in part on the first telemetry data.

24. The processor of claim 18, wherein the first network device is to stream a second one of the one or more telemetry streams to a fourth network device of the plurality of network devices, and
the first network device is to transmit the first telemetry data to the fourth network device.
